(19) United States
(12) Patent Application Publication
(10) Pub. No.: US 2017/0237118 A1
(43) Pub. Date: Aug. 17, 2017

(54) CUBIC IONIC CONDUCTOR CERAMICS FOR ALKALI ION BATTERIES

(71) Applicant: Brookhaven Science Associates, LLC, Upton, NY (US)

(72) Inventors: Peter Gabriel Khalifah, East Setauket, NY (US); Jue Liu, Port Jefferson Station, NY (US)

(21) Appl. No.: 15/586,895

(22) Filed: May 4, 2017

Related U.S. Application Data
(62) Division of application No. 13/873,380, filed on Apr. 30, 2013.
(60) Provisional application No. 61/640,114, filed on Apr. 30, 2012.

(51) Int. Cl. H01M 10/0562; H01M 10/054; H01M 10/0525

(52) U.S. Cl. CPC H01M 10/0562; H01M 10/0525; H01M 10/054; H01M 2300/0068

(57) ABSTRACT

The present invention relates solid electrolytes. The solid electrolyte compounds have a framework formula [MT₃X₁₀]ⁿ⁻ (1) and a general formula AₓMT₃X₁₀ (2), where M is a cation in octahedral coordination, T is a cation in tetrahedral coordination, X is an anion, and the framework has a net negative charge of −n, where a variable number of potentially mobile additional chemical species, A, can fit into the open space within this framework with a net charge of +n.

### CROSS-REFERENCE TO A RELATED APPLICATION

This application is a Divisional application of co-pending U.S. patent application Ser. No. 13/873,380, filed Apr. 30, 2013, which claims the benefit under 35 U.S.C. 119(e) of U.S. Provisional Application No. 61/640,114 filed on Apr. 30, 2012, the content of which is incorporated herein in its entirety.

### STATEMENT OF GOVERNMENT LICENSE RIGHTS

The present invention was made with government support under award number DE-SC0001294 made to the Northeastern Center for Chemical Energy Storage under EFRC program awarded by the U.S. Department of Energy and under contract number DE-AC02-98CH10886 also awarded by the U.S. Department of Energy. The United States government has certain rights in the invention.

### FIELD OF THE INVENTION

The present invention relates to electrochemical storage devices containing an electrolyte with high ionic conductivity, low impedance, and high thermal stability. More particularly, this invention relates to the design, synthesis and application of novel cubic ionic conductor compounds, as exemplified by nitridophosphate type compounds such as Na₃₋ₓLi_{y}V(PO₃)₃N which act as an electrode for alkali ion batteries, or as a solid state electrolyte for battery or other electrochemical applications.

### BACKGROUND

The demand for batteries to meet high power and high-energy system applications has resulted in substantial research and development activities to improve their safety, as well as performance. As the world becomes increasingly dependent on portable electronic devices, and looks toward increased use of electrochemical storage devices for vehicles, power distribution load leveling and the like, it is increasingly important that three key objectives are met: performance, safety, and cost.

In recent years, extensive world-wide efforts have been undertaken to develop systems that meet such criteria. At this Moment, lithium-ion batteries are the most promising candidates that meet these criteria due to their higher gravimetric and volumetric energy densities compared to other rechargeable battery systems such as lead-acid, nickel-cadmium and nickel-metal hydride batteries. Conventional lithium-ion batteries are fabricated with a lithium-containing cathode and a metallic lithium or carbon-based anode. However, conventional lithium-ion batteries still show substantial limitations in energy and power density due to the design of their cathodes.

One alternative to using a lithium-containing cathode and a metallic lithium or carbon-based anode is to use a sodium-ion battery with a sodium-containing cathode and a sodium-accepting anode to take advantage of the lower cost and greater abundance of sodium relative to lithium, especially for large-scale energy storage applications. Although such systems are promising from a cost perspective, the rate, lifetime, and voltage performance of sodium-ion batteries have to date been generally found to be inferior to those of lithium-ion batteries. A second alternative which has also proven to be more practical is to start with a sodium-containing cathode and to utilize a good Li-ion electrolyte to cycle it against a lithium-containing anode (such as Li metal), resulting in the electrochemical removal of Na from the cathode followed by the electrochemically-driven intercalation of Li into the cathode. Hybrid-ion battery performance which is competitive with Li-ion battery performance has been demonstrated in systems that include Na₂FePO₄F, Na₃V₂(PO₄)₂F₃ and Li₂NaV₂(PO₄)₃. (J. Barker et al. J. Electrochem. Soc.,154 (9) A882-A887 (2007); B. L. Cushing & J. B. Goodenough, J. Solid State Chem., 162, 176-181 (2001); and B. L. Ellis, et al., Nature Materials 6, 749-753 (2007); incorporated herein by reference in their entirety). There is a continuing need to develop new cathode materials for Li-ion, Na-ion, and hybrid-ion batteries that would allow large-scale and cost-effective energy storage that matches or exceeds current industry standards for safe and inexpensive storage application.

### SUMMARY

In view of the above-described problems, needs, and goals, a class of cubic ionic conductor compounds is provided that can be employed as an electrode in electrochemical storage and ionic conduction applications. These cubic ionic conductor (or “CUBICON”) compounds have the framework formula (1) and a general formula (2)

[MT₃X₁₀]ⁿ⁻ (1)

AₓMT₃X₁₀ (2)

where M is a cation in octahedral coordination, T is a cation in tetrahedral coordination, and X denotes anions. The framework has a net negative charge of −n. A variable number of additional chemical species, A, can fit into the open space within this framework with the constraint that they provide charge balance and have a net charge of +n. Although it is preferable that the A species are cations, it is also expected that neutral species or even anions could be accommodated in this framework. The A species can be relatively loosely bound and can move through a lattice, demonstrating good ionic conduction that makes this family of compounds useful for electrochemical applications.

One exemplary embodiment of the cubic ionic conductors (“CUBICON”) is a family of the nitridophosphate compounds having a general formula (3)

AₓM(PO₃)₃N (3)

For the family of the nitridophosphate compounds disclosed by general formula (3), the T₃X₁₀ portion of the cubic ionic conductor framework (1) ([MT₃X₁₀]ⁿ⁻) has the composition P₃O₉N (T=P, X=O, N), with a net charge (−n) of −6. These compounds are known to form the cubic ionic conductor framework with A and M independently selected from a set of monopositive (Na, K), dipositive (Mg, Mn, Fe, Co), or tripositive (Al, Ga, In, Ti, V, Cr, Mn, Fe) cations. As in formula (2), M is a framework cation in octahedral coordination, and A is a variable number of non-framework cations inserted into the open space within this framework. The total A and M cations is no more than four (L e., x≦3), and the sum of the charges of these four cations is +6 giving a net neutral composition (e.g., Na₃Ti(PO₃)₃N or Na₂Fe₂(PO₃)₃N). In some embodiments, however, the total A and M cations is more than four, whereby the oxidation state of M is reduced below its starting state, while the sum of the charges of these cations is still +6 giving a net neutral composition. Based on chemical and structural analogies, it is believed that additional cations having the above (1+, 2+, 3+) or different charges or chemical species, such as neutral or ionic small molecules, can be incorporated into this structure.

It is believed that the presence of the [MT₃X₁₀]ⁿ⁻ anion framework and the unique crystal structure of these compounds provide desirable electrochemical and ionic properties that allow cation mobility and reversible electrochemical cycling. In particular, it has been discovered that monopositive cations, such as sodium (Na), can be removed from these compounds at room temperature when redox-active cations are present so that the sum x+y is less than 4, preferably substantially less than 4. Electrochemical methods can be used to remove these monopositive cations and insert other monopositive cations, such as lithium (Li), in their place. The insertion and removal of cations can be done in a reversible fashion. In one exemplary embodiment, the cubic ionic conductor material has a sodium cation, a transition metal nitridophosphate anion framework, and a lithium cation that can be reversibly intercalated and de-intercalated within the crystal structure, with a variable formula such as Li₂₋ₓNaV(PO₃)₃N (0≦x≦2).

An electrode, preferably a cathode, is composed of a cubic ionic conductor compound having a framework of formula (1), a conductive additive, e.g., carbon black, and a binder, e.g., polyvinylidene difluoride. In one embodiment, the composition of the nitridophosphate compound, additive, and binder is about 50% to 100% of the nitridophosphate compound, 0% to 30% of additive, and 0% to 20% of binder. In a preferred embodiment the composition of the nitridophosphate, additive, and binder is about 80:10:10. Also disclosed herein is an electrochemical cell, a battery, having a cathode, an anode, and an electrolyte solution. In a preferred embodiment, the electrochemical cell is a lithium-ion battery, a hybrid-ion battery, or a sodium-ion battery having a cathode composed of the disclosed cubic ionic conductor compound, preferably a nitridophosphate compound. Although, the lithium-ion battery, the hybrid-ion battery, or the sodium-ion battery are preferred, it is also within the scope of this disclosure that the electrochemical cell can be of other types such as a semisolid flow cell (SSFC) batteries, in which a nitridophosphate electrode is produced by suspending particles in an electrolyte solution, rather than being cast as a solid film. (Duduta et al. Advanced Energy Materials 1(4), 2011, 511-516, incorporated herein by reference in its entirety).

The cubic ionic conductor compounds, such as nitridophosphates, exhibit substantial ionic conductivity. Thus, besides functioning as battery electrodes, these cubic ionic conductor compounds can also be utilized as solid state electrolytes in which they serve as a membrane or layer with high ionic conductivity but low electronic conductivity. The cubic ionic conductor compounds can also serve as the separator between electrodes in batteries, or as a coating for electrode active material in batteries. It is believed that the most suitable elemental components for ionic conductivity applications are those which have a closed shell of valence electrons, such as M=Mg²⁺, Zn²⁺, Ca²⁺, Sr²⁺, Sc³⁺, Al³⁺, Ga³⁺, In³⁺, Ti⁴⁺, Zr⁴⁺, Hf⁴⁺, V⁵⁺, Nb⁵⁺, Ta⁵⁺, Cr⁶⁺, Mo⁶⁺, and W⁶⁺. In a preferred embodiment, the nitridophosphate, as the cubic ionic conductor compound, will be substantially composed of one or a mixture of these elements.

Also disclosed herein is a method for synthesizing substantially pure nitridophosphate compound(s) based on a solid state mechanism using urea (CO(NH₂)₂) as a solid nitrogen source, optionally with a polymeric precursor (Pechini-type). The use of urea as a solid nitrogen source over just solid phosphorous oxynitride (PON) or ammonia gas (NH₃) of prior art provides the improved reaction rates and improved product purity. The method generally has the steps of (1) mixing stoichiometric amounts of metal oxide, a metaphosphate, and urea, (2) heating the mixture under flowing ammonia gas to about 350° C. at a rate of about 300° C./hour, and (3) heating the mixture to about 700 to 800° C. under flowing ammonia. In a preferred embodiment, the mixing of stoichiometric amounts of metal oxide, a metaphosphate, and urea can be accomplished by grinding or by using a vibratory ball mill. Depending on the selection of the metal oxide and metaphosphate, the time and temperature of the reaction may be adjusted accordingly without departing from the scope and spirit of the invention. In one exemplary embodiment, the mixture is heated at about 350° C. under flowing ammonia gas for several hours and at about 700 to 800° C. for about 10 to 30 hours under flowing ammonia. After heating the mixture at about 350° C. under flowing ammonia gas for several hours, the reaction product is preferably subjected to grinding.

Although, substantially pure nitridophosphate compound(s) can be synthesized based on a solid state mechanism using urea (CO(NH₂)₂) as a solid nitrogen source, optionally with a polymeric precursor (Pechini-type), a substantially pure nitridophosphate compound(s) can also be synthesized based on a solid state mechanism utilizing a phosphorus source other than PON or NaPO₃.

These and other characteristics of the nitridophosphate compound and methods of synthesis of such compounds will become more apparent from the following description and illustrative embodiments, which are described in detail with reference to the accompanying drawings. Similar elements in each figure are designated by like reference numbers and, hence, subsequent detailed descriptions of such elements have been omitted for brevity.

### BRIEF DESCRIPTION OF THE DRAWINGS

FIG. 1A and 1B are schematic illustrations of a cubic ionic conductor building block of a T₃X₁₀ trimer containing three tetrahedra and the trimer's three neighboring octahedra (viewed in two different orientations) for a representative nitridophosphate, Na₃VP₃O₉N, an example of an A₃MT₃X₁₀ cubic ion conductor.

FIG. 1C is a schematic illustration of the octahedral M cation coordination in the cubic ionic conductor structure of Na₃VP₃O₉N. Each MX₆ octahedron is connected to three different T₃X₁₀ trimers by two bridging anions connected to two different TX₄ tetrahedra within the trimer.

FIG. 2A is a schematic illustration of the framework structure (MT₃X₁₀) of the cubic ionic conductor phase with the composition of Na₃V(PO₃)₃N with Na atoms omitted for clarity.

FIG. 2B is a schematic illustration of the full structure (A₃MT₃X₁₀) of the cubic ionic conductor phase with the composition of Na₃V(PO₃)₃N shown in FIG. 2A with the A species (Na atoms) shown inside the MT₃X₁₀ framework.

FIG. 3A is a schematic illustration of the framework structure of the cubic ionic conductor phase of Na₂Fe₂(PO₃)₃N with Na atoms omitted, and the Fe2 octahedron opened to reveal the Fe2 atom that sits on the position corresponding to the Na2 site of the Na₃V(PO₃)₃N structure.

FIG. 3B is a schematic illustration of the framework structure of the cubic ionic conductor phase of Na₂Fe₂(PO₃)₃N shown in FIG. 3A including the Na atoms, which sit on the positions corresponding to the Na1 and Na3 sites in Na₃V(PO₃)₃N.

FIG. 4A is a plot of X-ray diffraction patterns of Na₃V(PO₃)₃N obtained by a conventional solid state synthesis from different synthesis temperatures for 20 hours. From top to bottom: (1) 700° C. with urea; (2) 850° C.; (3) 800° C.; (4) 750° C.; (5) 700° C.; and (6) 675° C.

FIG. 4B is a plot of X-ray diffraction (XRD) patterns of Na₃V(PO₃)₃N obtained from different sintering times at 700° C. From top to bottom: (1) 25 hours, (2) 20 hours, and (3) 12 hours.

FIG. 4C is a plot of an XRD pattern of Na₃V(PO₃)₃N obtained from urea-added (100% molar ratio) starting material which was heated to 600° C. for 20 hours, with the reaction product washed by distilled water prior to X-ray analysis.

FIG. 5A is a plot of X-ray diffraction patterns of Na₃Ti(PO₃)₃N obtained by a conventional solid state synthesis at different sintering temperatures. From bottom to top: (1) 700° C.; (2) 750° C.; (3) 800° C.; and (4) 750° C. with a distilled water wash.

FIG. 5B is a plot of X-ray diffraction patterns of Na₃Ti(PO₃)₃N obtained by a conventional solid state synthesis at 750° C. From top to bottom: (1) 25 hours, (2) 20 hours, and (3) 12 hours.

FIG. 5C is a plot of an X-ray diffraction pattern of Na₃Ti(PO₃)₃N obtained from urea-added starting materials and washed by diluted HCl (1:10) solution.

FIG. 6A is a plot of XRD patterns of Na₃V(PO₃)₃N synthesized by different methods, including from bottom to top (a) a conventional solid state synthesis at 700° C. for 20 hours, (b) a solid state synthesis with urea added in an equimolar amount relative to vanadium and heating at 600° C. for 20 hours (c) a solid state synthesis that utilized sodium acetate and diammonium hydrogen phosphate starting materials and ascorbic acid as an additive, and heating at 650° C. for 15 hours (d) a sol-gel method and heating at 650° C. for 15 hours.

FIG. 6B is a plot of X-ray diffraction patterns of Na₃Ti(PO₃)₃N synthesized by methods including from bottom to top (a) a conventional solid state synthesis at 750° C. for 20 hours, (b) a solid state synthesis with urea added in an equimolar amount relative to titanium and heating at 700° C. for 20 hours (c) a solid state synthesis that utilized sodium acetate and diammonium hydrogen phosphate starting materials and ascorbic acid as an additive, and heating at 650° C. for 15 hours. Pattern (d) is the partially desodiated sample, Na₃₋ₓTi(PO₃)₃N with x˜0.6, that resulted from washing the product of the conventional solid state reaction with diluted HCl (1:10), which exhibits a prominent 002 peak at around 18 degrees two-theta.

FIG. 7 is a plot of X-ray diffraction patterns of Na₂Fe₂(PO₃)₃N synthesized by different methods, including from bottom to top (a) a conventional solid state synthesis and heating at 650° C. for 20 hours and (b) using a solid state synthesis that utilized sodium acetate and diammonium hydrogen phosphate starting materials and ascorbic acid as an additive, and heating at 650° C. for 15 hours.

FIG. 8A is a plot of cycling performance of a hybrid-ion battery made with a Na₃Ti(PO₃)₃N cathode and a Li metal anode which was measured between 2.5 V and 4.5V at C/10 rate during the first charge-discharge cycle.

FIG. 8B is a plot of cycling performance of a hybrid-ion battery made with a Na₃Ti(PO₃)₃N cathode and a Li metal anode which was measured between 2.5V and 4.5V at C/10 rate over the first three charge-discharge cycles.

FIG. 8C is a plot of cycle life performance over 20 cycles of a hybrid-ion battery made with a Na₃Ti(PO₃)₃N cathode and a Li metal anode which was measured between 2.5V and 4.5V at a C/5 rate.

FIG. 9 is a plot of cycling performance of a hybrid-ion battery made from Na₃V(PO₃)₃N. The first ten charge-discharge curves were measured at room temperature at a C/8 ratio.

FIG. 10A is a plot of cycling performance of a sodium-ion battery made with a Na₃Ti(PO₃)₃N cathode (acetate method) and a Na metal anode which was measured between 2.0V and 3.5V at a C/10 rate. The low voltage plateau around 2.1 V is due to the response of a Na₃Ti₂(PO₄)₃ impurity phase.

FIG. 10B is a plot of cycling performance lifetime of a sodium-ion battery made with a Na₃V(PO₃)₃N cathode (urea added solid state reaction) and a Na metal anode which was measured between 2.5V and 4.2V at a C/20 rate.

FIG. 11 is a spectrum of X-ray diffraction patterns of the in-situ heating of the HCl-washed Na₃₋ₓTi(PO₃)₃N sample with an X-ray wavelength of 0.3196 Å. (Data were collected with a 2D area detector and a temperature increasing rate of 2° C./min up to 850° C., and with a final scan at room temperature at the end of the run).

FIG. 12A is an SEM image of the as-prepared Na₃Ti(PO₃)₃N sample obtained from the reaction (750° C., 20 hours, flowing NH₃) of NaPO₃ and TiO₂ (rutile, micrometer particles) starting materials.

FIG. 12B is an SEM image of the as-prepared Na₃Ti(PO₃)₃N sample obtained by reacting (650° C., 15 hours, flowing NH₃) the starting materials of Na(CH₃COO), (N₄)₂HPO₄, and TiO₂ (rutile, <32 nm particle).

FIG. 13A is an SEM image of the as-prepared Na₃V(PO₃)₃N sample obtained from a solid state synthetic route (700° C., 20 hours, flowing NH₃) using NaPO₃ and V₂O₅ as starting materials.

FIG. 13B is an SEM image of the as-prepared Na₃V(PO₃)₃N sample obtained using the Pechini method (final reaction at 650° C. for 20 hours, flowing NH₃) with NaPO₃, NH₄VO₃ and citric acid used as starting materials.

FIG. 14 is an SEM image of the as-prepared Na₂Fe₂(PO₃)₃N sample obtained from a solid state synthetic route (600° C., 20 hours, flowing NH₃) using NaPO₃, Fe₂O₃ and (NH₄)HPO₄ as starting materials.

FIG. 15A is a plot of the XANES spectra obtained for Na₃Ti(PO₃)₃N before and after sodium removal. The oxidation state of Ti approached 4+ after desodiation, indicating that the removal of Na is nearly complete or complete.

FIG. 15B is a plot showing EXAFS analysis of the Ti X-ray absorption edge for Na₃Ti(PO₃)₃N. The local environment of Ti is not substantially changed by desodiation, suggesting that the cubic ionic conductor structure is preserved during the process of Na removal.

FIG. 16A is a plot of the in situ XANES spectrum obtained for Na₃VP₃O₉N (vs. Li⁺/Li) during the first charge of the in situ coin cell to 4.9 V (scan 29).

FIG. 16B is a plot of the in situ XANES spectrum obtained for Na₃VP₃O₉N (vs. Li⁺/Li) during the discharge of the in situ coin cell to 1.1 V (scan 55).

FIG. 17A is a plot of electrochemical performance of Na₃VP₃O₉N cathode cycled against Li metal. Voltage charge/discharge curve with capacity retention of Na₃VP₃O₉N versus Li⁺/Li cycled between 1 V and 4.9 V at C/36. The first cycle is shown in black and the second cycle is shown in red.

FIG. 17B is a plot of the gravimetric capacity of the Na₃V(PO₃)₃N system shown in FIG. 17A, which increases beyond the theoretical capacity for cycling V³⁺ [symbol] V⁵⁺ after the first charge cycle.

FIG. 18A is a plot of the electrochemical performance (charge/discharge) of Li₃V(PO₃)₃N cathode cycled against Li⁺/Li between 2 V and 4.2 V at C/15, corresponding to current density of 0.02 mA/cm².

FIG. 18B is a plot of the gravimetric capacity (up to 10 cycles) of the Li₃V(PO₃)₃N system shown in FIG. 18A cycled against Li⁺/Li between 2 V and 4.2 V at C/15.

FIG. 19A is a plot of the electrochemical performance (charge/discharge) of Li₂₊ₓTi(PO₃)₃N cathode cycled against Li⁺/Li between 1.5 V and 3.2 V at C/15, corresponding to current density of 0.015 mA/cm².

FIG. 19B is a plot of the gravimetric capacity (up to 10 cycles) the Li₂₊Ti(PO₃)₃N system shown in FIG. 19A cycled against Li⁺/Li between 1.5 V and 3.2 V at C/15.

FIG. 20A is a plot of the electrochemical performance (charge/discharge) of LiₓFe₂(PO₃)₃N cathode cycled against Li⁺/Li between 1.5 V and 3.2 V at C/15, corresponding to current density of 0.012 mAkm².

FIG. 20B is a plot of the gravimetric capacity (up to 20 cycles) of the LiₓFe₂(PO₃)₃N system shown in FIG. 20A cycled against Li⁺/Li 1.5 V and 3.2 V at C/15.

### DETAILED DESCRIPTION

A cubic ionic conductor compound is disclosed that can be employed as an electrode or electrolyte in electrochemical storage and ionic conduction applications. These CUBic Ionic CONductor (or “CUBICON”) compounds have the framework formula (1)

[MT₃X₁₀]ⁿ⁻ (1),

having a space group which is either P2₁3 or slightly distorted form of this space group and a general formula (2),

AₓMT₃X₁₀ (2)

where M is one or more charged cations in octahedral coordination, T is one or more cations that adopt tetrahedral coordination, and X denotes anions. The framework has a net negative charge of −n. The framework belongs to the same structural family as Na₃Ti(PO₃)₃N as evidenced by a T₃X₁₀ trimer of TX₄ tetrahedra sharing one common anion, organized around an octahedral MX₆ site such that each MX₆ octahedron is connected to three different T₃X₁₀ trimers by two bridging anions that connect to two different TX₄ tetrahedra within the trimer. A variable number of additional chemical species, A, can fit into the open space within this framework with the constraint that they provide charge balance and have a net charge of +n. Although it is preferable that the A species are cations, and even more preferable that the A species are one or more monopositive cations, it is also expected that neutral species or even anions could be accommodated in this framework. The A species can be relatively loosely bound and can move through a lattice such as an electrode lattice, demonstrating good ionic conduction that makes this family of compounds useful for electrochemical applications. Examples of the cubic ionic conductor compounds include nitridophosphates such as Na₃Al(PO₃)₃N, Na₃Ti(PO₃)₃N, Na₃V(PO₃)₃N, K₃Ti(PO₃)₃N, K₃V(PO₃)₃N, Na₂Mg₂(PO₃)₃N and Na₂Fe₂(PO₃)₃N, desodiated nitridophosphate compounds such as Na₂Ti(PO₃)₃N and Na₁V(PO₃)₃N, and Li-intercalated nitridophosphates such as LiNa₂Ti(PO₃)₃N and Li₂Na₁V(PO₃)₃N. Other possible examples of the cubic ionic conductor compounds include Na₂(NH₄)Ti(PO₃)₃N, Na₂AgTi(PO₃)₃N, Li₃V(PO₃)₃N, Li₂Fe₂(PO₃)₃N, Na_{2.5}FeV_{0.5}(PO₃)₃N, Na₃Mo(PO₃)₃N, Na₂V₂(SiO₃)₃N, NaFe(SO₃)₃N, and Na₃V(SO₂N)₃N. Compounds will be recognized as still belonging to the cubic ionic conductor family if the nitridophosphate compound undergoes tetrahedral changes such as from PO₃N to PO₄, PO₂N₂, PON₃, PN₄, SiO₄, VO₄, MoO₄, VO₃N, SO₃N, SiO₃N, etc. Of these cubic ionic conductor compounds, nitridophosphates are preferred.

The present cubic ionic conductor compound(s), and preferably the crystalline or semi-crystalline form of these compounds, are also encompassed in an electrode, which can be used in the production of one or more electrochemical systems. In addition, methods of synthesizing the cubic ionic conductor compounds are disclosed. It is to be understood, however, that those skilled in the art may develop other structural and functional modifications without significantly departing from the scope of the disclosed invention.

### I. Nitridophosphate Material(s)

The nitridophosphate is a preferred embodiment of the CUBICON compound having a framework disclosed in formula (1) with a general formula (2) that can be employed as an electrode or electrolyte in electrochemical storage and ionic conduction applications. The nitridophosphate material can form crystalline particles described by a general formula

AₓM(PO₃)₃N (3)

where x≦3. In a preferred embodiment x is between 0 and 3. In a more preferred embodiment, x is between 1 and 3. In yet even more preferred embodiment, x is between 2 and 3, and in even more preferred embodiment x is about 3. In yet another embodiment, x can be greater than 3 for the nitridophosphate material of formula (3) that can accept excess ions. As in formula (2), M is a framework cation in octahedral coordination, and A are non-framework cations inserted into the open space within this framework. These non-framework A cations include a variable number of mobile or a combination of mobile and immobile cations (i.e., A^{M}ₓM(PO₃)₃N or (A^{M}A_{I})ₓM(PO₃)₃N, where A^{M} are mobile cations and A^{I} are immobile cations). The mobile A cations are preferably wholly or partially monopositive cations and can be mobile under ambient conditions or can become mobile at elevated temperature or at non-equilibrium electrochemical potentials. In contrast, the more highly charged M cation(s) help preserve the framework and do not freely diffuse through the solid. The mobile A cations can potentially be intercalated or de-intercalated when the cubic ionic conductor compound contains redox-active cations. The mobile cation A is preferably selected from one or more monopositive cations or cationic functional groups: hydrogen (H), lithium (Li), sodium (Na), potassium (K), silver (Ag), copper (Cu), ammonium (NH₄) and hydronium (H₃O). However, it is also envisioned that the mobile A cations can be divalent. The immobile cation A and the framework cation M are independently selected from one or more cations that can be accommodated in the structure, such as Sc, Ti, V, Cr, Mn, Fe, Co, Ni, Zn, Cu, Al, Ga, In, Mg, and Ca. It is believed that the presence of [(PO₃)₃N]⁶⁻ anion and the unique crystal structure of these compounds provide desirable electrochemical properties that allow cation mobility and reversible electrochemical cycling. For example, the nitridophosphate compound(s) form crystalline structure showing excellent capacity (e.g., 140 mAh/g for Na₃₋ₓLiₓV(PO₃)₃N (0<x<2)) at a high working potential (e.g., 4.1 V for Na₃₋ₓLiₓV(PO₃)₃N vs. 3.4 V for LiFePO₄). For the nitridophosphate compounds of formula (3), the ability to reduce M to oxidation states lower than its starting state enables the structure to accept excess mobile cations, which can further increase the theoretical capacity of the nitridophosphate compound(s). (e.g., 233 mAh/g for Li₃NaVP₃O₉N (V²⁺ [symbol] V⁵⁺) vs. 158 mAh/g for Li₂NaVP₃O₉N (V³⁺ [symbol] V⁵⁺)).

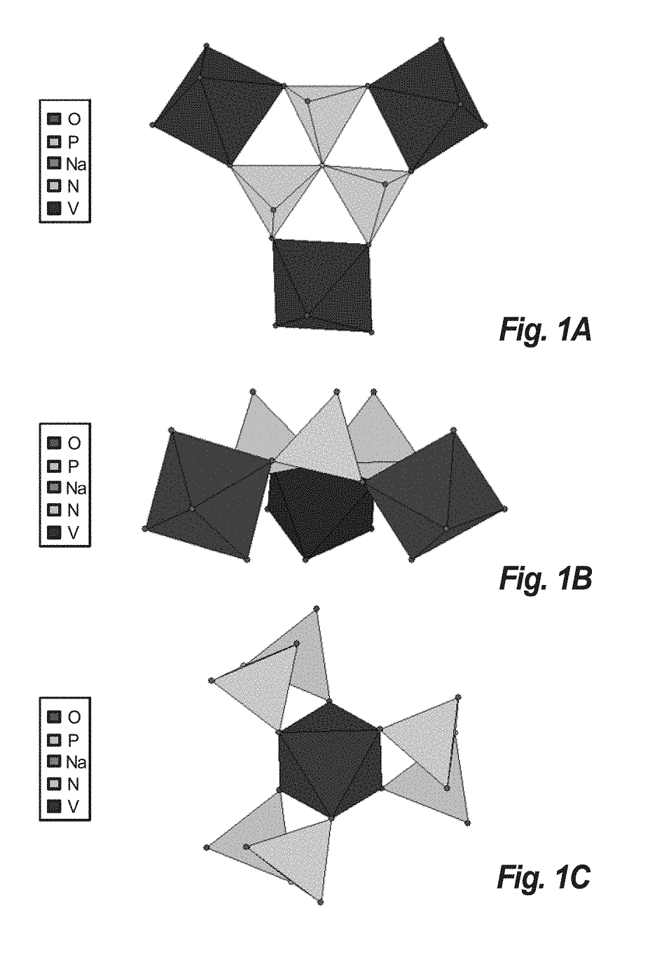

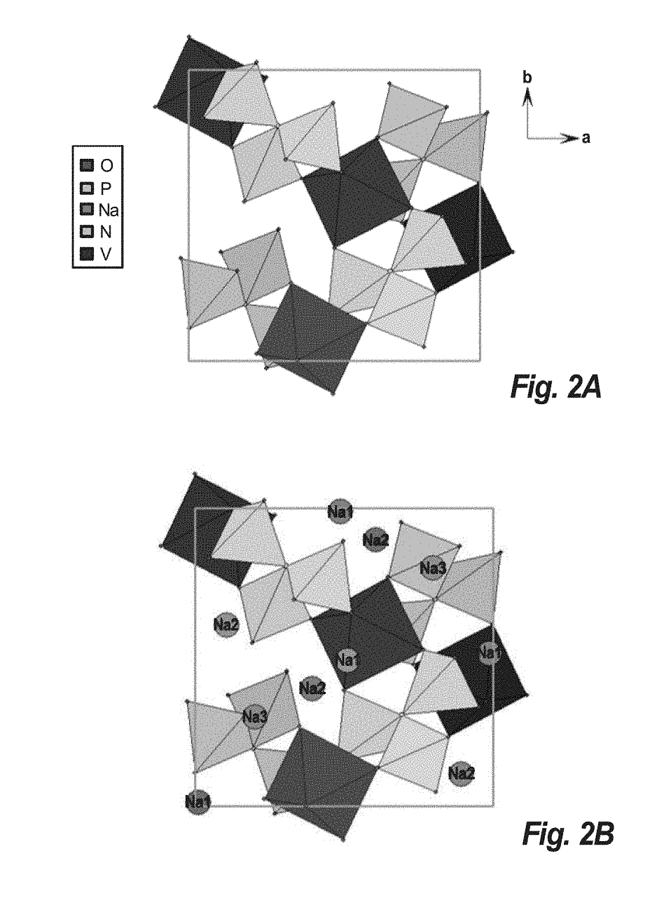

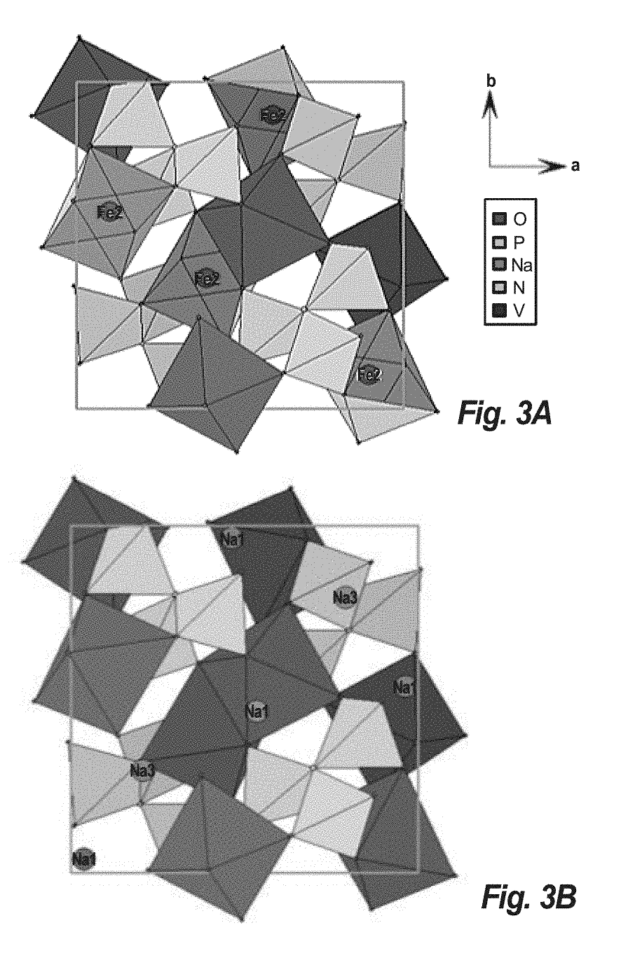

The crystalline particles of nitridophosphate compounds have a cubic non-centrosymmetric structure with the space group of P2₁3. The [(PO₃)₃N]⁶⁻ anion in these compounds is formed by three PO₃N tetrahedra sharing one N vertex as illustrated in FIG. 1A and 1B of a representative nitridophosphate Na₃VP₃O₉N. The building block of the nitridophosphate is a (PO₃)₃N (or P₃O₉N), trimer of three tetrahedra that are connected to three neighboring octahedra via corner-shared oxygens, where each pair of tetrahedra share two corners of a VO₆ octahedron. In contrast, the M cation has octahedral coordination in the cubic ionic conductor structure as shown in FIG. 1C. Each corner of the MX₆ octahedron is shared with a TX₄ tetrahedron, allowing connections with two neighboring tetrahedra in each of three different T₃X₁₀ trimers of tetrahedra. As illustrated in FIGS. 2A and 2B the framework structure of the cubic ionic conductor allows free movement of Na atoms from A sites and replacement of these atoms with, for example, Li. In this exemplary embodiment, the structure has three different A sites for non-framework (or intercalated) cation occupancy (e.g., Na1, Na2, Na3) when x is 3. However, without being bound by theory, it is believed that other mobile cations may or may not occupy the same A sites of the crystalline nitridophosphate compounds, particularly, since other monopositive cations, such as Li or K, have different sizes and/or bonding preferences as compared to Na. The non-framework Na sites can potentially also be occupied by cations with different charges. For example, in a crystalline nitridophosphate compound of formula (3) where x=3 illustrated in FIG. 3A and 3B, it is believed that the second divalent immobile cation A (e.g., Fe) atom occupies the site designated as Na2 (shown in FIG. 2B) for the different nitridophosphate compound Na₃VP₃O₉N.

The cations occupying the A sites can be removed from the nitridophosphate compounds of formula (3) by electrochemical and/or chemical techniques known in the art to produce typically substoichiometric compounds that provide reversible storage capacity. While the crystal structure remains cubic, it is also possible without departing from the scope of this invention that the symmetry of the substoichiometric compounds can be different from that of the stoichiometric material. Such a change in symmetry may also occur for chemically substituted or doped nitridophosphate compounds. Since there is known variation in the type and position of the A and M cations, the structure of the nitridophosphate compound is best defined by the connectivity of its tetrahedral units. Thus, compounds can be recognized as belonging to this nitridophosphate structural family if they share the same network topology of tetrahedral units as the structure prototype of Na₃Al(PO₃)₃N illustrated in FIG. 1. Compounds recognized as still belonging to this nitridophosphate family include replacement of PO₃N with PO₄, PO₂N₂, PON₃, PN₄, SiO₄, VO₄, MoO₄, VO₃N, SO₃N, SiO₃N, etc., so long as the network topology remains intact. While it is preferred that the nitridophosphate compound(s) of formula (3) are partially or fully crystalline, it is possible that this compound can also be amorphous. For example, synthesis reactions designed to give products of formula Na₃Mn(PO₃)₃N do not give X-ray diffraction peaks characteristic of a crystalline phase even after heating at temperatures as high as 800° C. This suggests that the components of the nitridophosphate structural family may also exist without a well-defined network topology.

In one preferred embodiment the nitridophosphate compound of formula (3) has three sodium (Na) cations per formula unit as the non-framework species A and one or more metals on the single framework site M with a net oxidation state that results in a charge-balanced compound. This nitridophosphate compound is described by a formula (4),

Na₃M(PO₃)₃N (4)

Preferably, M is selected from Al, Sc, Ti, V, Cr, Mn, Fe, Ga, In, or a mixture of these cations, such as Al(III)/V(III), or as a mixture of cations whose average valence is three, such as Mg(II)/V(IV). In one exemplary embodiment a stoichiometric sodium nitridophosphate compound can have a formula Na₃Ti(PO₃)₃N (5) or Na₃V(PO₃)₃N (6). The sodium, however, can be removed from these nitridophosphate compounds by electrochemical and/or chemical techniques known in the art to produce Na₃₋ₓM(PO₃)₃N (7), where x indicates the degree of substoichiometry with a maximum theoretical value dependent on the transition metal employed in M. For example the maximum theoretical value for M=Ti is x=1, while the maximum theoretical value for M=V is x=2. This removal (and/or re-insertion) of Na allows these compounds to perform as intercalation-type sodium-ion batteries.

In another preferred embodiment, lithium (Li) can be introduced into the nitridophosphate compounds of formula (7) to produce lithium-containing materials having formula: Na₃₋ₓLi_{y}M(PO₃)₃N (8) that show reversible storage capacity. In particular, these lithium-containing materials can be reversibly intercalated and de-intercalated with Li in a manner that is useful for batteries. The compounds of formula (8) that are employed to produce electrodes for the batteries would typically be named Li-ion battery materials if the Li was directly inserted during the synthesis, or hybrid ion battery materials if Na was electrochemically de-intercalation prior to Li insertion. The number of Li cations that can be intercalated into these compounds can range between 0 and x. The process can occur at a potential voltage prescribed by the selected redox-active metal (M). For example, the potential voltage to intercalate Li if the M atom is Ti is about 2.8 V (vs. Li metal), whereas the potential voltage to intercalate Li if the M atom is V is about 4.1 V (vs. Li metal). These are suitable voltages for these materials to serve as cathodes in electrochemical devices. The higher potential (e.g., M=V) is particularly desirable, as it optimizes the energy storage density without compromising the stability of the device. The potentials are approximate, as the each potential will vary depending on the exact state of charge/discharge (i.e. precise value of x), as well as the chosen charge rate, the battery fabrication process, and a number of other variables.

In another preferred embodiment the nitridophosphate compound of formula (3) has two mobile sodium (Na) cations per formula unit as the non-framework species A, one redox-active immobile cation (A^{I}) per formula unit also as the non-framework species A and one redox-active framework cation (M) per formula unit. The immobile redox-active cations A^{I} and M have an average oxidation state of 2+, resulting in a charge-balanced compound. This nitridophosphate compound is described by a formula (9),

Na₂A^{I}M(PO₃)₃N (9),

Preferably, A^{I} and M are selected from Mg, V, Cr, Mn, Fe, Co, Ni, Zn, Ca, or a mixture of these cations. Preferably, A^{I} and M are selected from the same chemical species (e.g., Na₂Fe₂(PO₃)₃N), although A^{I} and M can be different as well. Similarly to the nitridophosphate compounds shown in formula (7), the sodium can be removed to produce a nitridophosphate compound with a formula Na₂₋ₓA^{I}M(PO₃)₃N (10), where x indicates the degree of substoichiometry with a maximum theoretical value dependent on the transition metals employed as A^{I} and M. Lithium (Li) can be introduced into the nitridophosphate compounds of formula (10) to produce lithium based materials having formula: Na₂₋ₓLi_{y}A^{I}M(PO₃)₃N (11) that show reversible storage capacity.

In one embodiment, the nitridophosphate compound of formula (3) can accept excess mobile ions by reducing the oxidation state of M below its starting state. The nitridophosphate compound that can accept excess mobile ions has formula:

A₃₊ₓM^{z-w}(PO₃)₃N (12),

where a combination of A₃₊ₓM^{z-w} yields a net charge of +6, z is the starting oxidation state of M, and w is a reduction in the oxidation state defined as 0<w≦2, preferably 0<w≦1. In a preferred embodiment x is between 0 and 3. In a more preferred embodiment, x is between 0 and 2. In even more preferred embodiment, x is between 0 and 1. In the most preferred embodiment, x is about 1. M is a framework cation that can reduce its oxidation state below the starting state in order to accommodate the excess mobile ions (A), such as V, Cr, Mn, Ti, Co, Ni, and Fe. The mobile cation A is preferably selected from one or more monopositive cations or cationic functional groups: H, Li, Na, K, Ag, Cu, NH₄ and H₃O. However, it is also envisioned that the mobile A cations can be divalent.

In one exemplary embodiment, M is vanadium (V) and the nitridophosphate compound that can accept excess mobile ions has formula,

A₃₊ₓV^{3-w}(PO₃)₃N (13),

where A is Na, Li or a mixture of Na and Li cations, and x and w is between 0 and 1. Preferably x and w is about 1. The theoretical capacity of such nitridophosphate compound (e.g., Li₃NaVP₃O₉N, ˜233 mAh/g; V²⁺< [symbol] V⁵⁺) is substantially greater than that of a compound at its initial oxidation state (e.g., Li₂NaVP₃O₉N, ˜158 mAh/g; V³⁺ [symbol] V⁵⁺). It is believed that the ability to reduce V to oxidation states lower than its starting state of 3+ is enabled by the ability of the structure to accept excess mobile cations. In yet another preferred embodiment, instead of sodium in the nitridophosphate compound(s) of formula (7), (8), (10), and (11), these compounds can be produced with potassium (K) (i.e., K₃₋ₓLi_{y}Na_{z}M(PO₃)₃N and K₂₋ₓLi_{y}Na_{z}A^{I}M(PO₃)₃N (14 and 15). Since the potassium will expand the crystal lattice of these compounds, it is believed that these compounds will have improved Na and/or Li mobility and improved battery charge/discharge rate performance.

In one embodiment the nitridophosphate compound of formula (3) has three lithium (Li) cations per formula unit as the non-framework species A and one or more metals on the single framework site M with a net oxidation state that results in a charge-balanced compound. This nitridophosphate compound is described by a formula (16),

Li₃M(PO₃)₃N (16)

In certain embodiments, M is selected from Al, Sc, Ti, V, Cr, Mn, Fe, Ga, In, or a mixture of these cations, such as Al(III)/V(III), or as a mixture of cations whose average valence is three, such as Mg(II)/V(IV). In exemplary embodiments a stoichiometric lithium nitridophosphate compound can have a formula Li₃Ti(PO₃)₃N, Li₃V(PO₃)₃N, Li₃Al(PO₃)₃N, Li₂Mg₂(PO₃)₃N, LiₓFe₂(PO₃)₃, or Li₂₊ₓTi(PO₃)₃N where x indicates the degree of substoichiometry with a maximum theoretical value dependent on the transition metal employed in M. Compared to their sodium-ion analogues, these lithium version materials may increase the theoretical capacity of the materials by about 15%, which is advantageous for energy storage.

In another embodiment, the nitridophosphate compound can further be doped with other elemental (cations, anions, or neutral) and molecular species (with a radius of less than 2 Å) in a manner that preserves the framework of the cubic ionic conductor compound. The elements which can substitute on the octahedral M sites of the framework include Li, Na, Mg, Al, Si, P, S, Sc, Ti, V, Cr, Mn, Fe, Co, Ni, Cu, Zn, Ga, Ge, Zr, Nb, Mo, Tc, Ru, Rh, Pd, Ag, Cd, In, Sn, Sb, Hf, Ta, W, Re, Os, Ir, Pt, Au, and Hg. Some species which may populate the A sites and others which will reside within the voids of the framework. These species include, but are not limited to, H, H₂O, H₃O, OH, NH₃, NH₄, N₂, O₂, Li, Na, K, Rb, Cs, Be, Mg, Ca, Sr, Ba, Al, Si, P, S, Sc, Ti, V, Cr, Mn, Fe, Co, Ni, Cu, Zn, Ga, Ge, Zr, Nb, Mo, Tc, Ru, Rh, Pd, Ag, Cd, In, Sn, Sb, Hf, Ta, W, Re, Os, Ir, Pt, Au, and Hg. It is also equally possible that the A sites can be substituted with Y, La, Zr, Hf, Ce, Pr, Nd, Pm, Sm, Eu, Gd, Tb, Dy, Ho, Er, Tm, Yb, Lu, Th, Pa, U, Np, and Pu. Substitutions can be incorporated into the tetrahedral TX₄ group in a number of different ways. For instance, tetrahedral TO₄ groups can have a p-block element as T (T=B, N, Al, Si, P, S, Cl, Ga, Ge, As, Se, In, Sn, Sb, Te, Tl, Pb, Bi, Po), or one of a number of metals which are also known to adopt tetrahedral coordination (TO₄ with T=Ag, Co, Cr, Cu, Fe, Mn, Mo, Ni, Re, Ru, Ti, V, W, Zn, Zr). In addition to the PO₃N tetrahedra which are constituents of the nitridophosphate compounds, other mixed or substituted TX₄ groups in which oxygen is substituted by another p-block anion (e.g., B, C, N, F, etc.) are known that can form groups, such as PO₂N₂, PON₃, PN₄, PO₃S, PO₃F, PO₂F₂, PO₂Cl₂, SO₃N, SO₃F, SO₃Cl, SiO₃N, SiO₂N₂, SiON₃, and SiN₄.

### II. Electrodes and Electrochemical Cells

As with most batteries, the electrochemical cell has an outer case made of metal or other material(s) or composite(s). The electrochemical cell is preferably a non-aqueous battery for the high power applications, though aqueous batteries may be preferred for stationary power applications where material cost is the primary concern. The case holds a positive electrode (cathode); a negative electrode (anode); a separator and an electrolyte solution, where the present cubic ionic conductor material(s) can be used in production of the cathode or anode. In a preferred embodiment, the electrochemical cell is a lithium-ion battery having a cathode composed of a nitridophosphate compound of the present invention. In another preferred embodiment, the electrochemical cell is a hybrid-ion battery having a cathode composed of a nitridophosphate compound of the present invention. In another preferred embodiment, the electrochemical cell is a sodium-ion battery having a cathode composed of a nitridophosphate compound of the present invention. In yet another preferred embodiment, the nitridophosphate compound of the present invention is used for ionic conduction.

In one embodiment, both the anode and cathode are formed from materials that allow lithium migration. For example, when the battery discharges, lithium ions move through the electrolyte from the negative electrode to the positive electrode and insert into the cubic ionic conductor crystalline particles. During recharge/charge, the lithium ions move back to the anode from the cathode. Inside the case both the anode and the cathode are in contact with an organic solvent that acts as the electrolyte. The electrolyte is composed of one or more salts, one or more solvents, and, optionally, one or more additives, or may alternatively be a solid state electrolyte consisting of an ionic conductor which could be lithium phosphorus oxynitride (LiPON), a sodium super-ionic conductor (NASICON), a lithium super-ionic conductor (LISICON), sulfonated tetrafluoroethylene polymer (NATION), β″-alumina or another similar material. In some embodiments, the cubic ionic conductor (or “CUBICON”), such as a nitridophosphate, can be used as a solid state electrolyte.

As a cathode in the Li-ion or hybrid ion battery, cubic ionic conductor compound of formula (2), and preferably nitridophosphate of formula (3), can provide a high capacity, reversible cycling, and performance high specific energy density. It is contemplated that the gravimetric capacity of the cathode containing the nitridophosphate material(s) of formula (3) are between 50 and 250 mAh g⁻¹, the Coulombic efficiency is between 50% and 100% and the cycling life is more than 10 cycles. Preferably, the cathode is composed of a nitridophosphate compound, a conductive additive, and a binder. The composition of the nitridophosphate compound, additive, and binder is about 50% to 100% of the nitridophosphate compound, 0% to 30% of additive, and 0% to 20% of binder. In a preferred embodiment the composition of the nitridophosphate compound, additive, and binder is 80:10:10. Another preferred embodiment is as the cathode in a flow battery cell (Bartolozzi et al., J. Power Sources, 27, 219, 1989; U.S. Pat. Publ. No. 2010/0047671 to Chiang et al.; both incorporated herein by reference in their entirety), where particles of the nitridophosphate can be suspended in an ion-conducting electrolyte and would require much less of a conductive additive (0 to 5%) and no binder.

The electrode may include the cubic ionic conductor materials of formulae 1-13. With specific reference to the cathode in Li-ion (including hybrid-ion) applications, in addition to the cubic ionic conductor material the cathode may also have at least one other lithium mixed metal oxide (Li-MMO) made out of a material capable of serving as a cathode in a Li-ion battery or a Li-ion conductor. Preferably, materials such as NASICON (such as Na₃M₂(PO₄)₃ with M typically being a 3d transition metal) and LISICON (such as Li₃M₂(PO4)₃ with M typically being a 3d transition metal) can be used as these compounds have been observed to occur as impurities or degradation products when producing or utilizing nitridophosphate compounds. Other examples of Li-MMOs may be used in the cathode include: LiMO₂ (M=Co, Ni, Mn, another 3d transition metal, or a combination thereof), LiM₂O₄ (M=Co, Ni, Mn, another 3d transition metal, or a combination of these metals), LiMPO₄ (M=Fe, Co, Ni, Mn, another 3d transition metal, or a combination of these metals), Li₂Cr₂O₇, Li₂CrO₄. Furthermore, transition metal oxides such as MnO₂ and V₂O₅; transition metal sulfides such as FeS₂, MoS₂, and TiS₂; and conducting or non-conducting polymer binders such as polyaniline, polypyrrole, polyvinylidene fluoride, styrene-butadiene rubber, polyamide or melamine resin, and combinations thereof may also be present as performance-enhancing additives. Preferably, the full-cell capacity is between 50 and 300 mAh g⁻¹.

With specific reference to the anode, it may contain lithium metal, carbon, silicon, or a carbon-, lithium, or silicon-based alloy. The carbon may be in the form of graphite such as, for example, mesophase carbon microbeads (MCMB). Lithium metal anodes may be lithium mixed metal oxide (MMOs) such as LiMnO₂ and Li₄Ti₅O₁₂. Alloys of lithium with transition or other metals (including metalloids) may be used, including LiAl, LiZn, Li₃Bi, Li₃Cd, Li₃Sd, Li₄Si, Li_{4.4}Pb, Li_{4.4}Sn, LiC₆, Li₃FeN₂, Li_{2.6}Co_{0.4}N, Li_{2.6}Cu_{0.4}N, and combinations of these metals. The anode may further comprise another metal oxide including SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, and combinations of these metal oxides. The anode may further comprise a polymeric binder. In a preferred embodiment, the binder may be polyvinylidene fluoride, styrene-butadiene rubber, polyamide or melamine resin, and combinations of these binders.

Although, a preferred embodiment has been described with reference to the lithium ion based electrochemical cells, it is also envisioned that the cubic ionic conductor materials can also be successfully applied to other electrochemical cells, such as hybrid electrochemical cells (HEC), supercapacitors, fuel cells, redox-flow batteries, and other ionic conductors.

### III. Synthesis of the Nitridophosphate Materials

Also disclosed herein are the methods for synthesizing nitridophosphate compound(s) having a formula (3) by employing a solid state or a polymeric complex method. One aspect of these methods is how the nitrogen and phosphorus are provided (i.e. nitrogen via a solid precursor such as phosphorus oxynitride (PON) or a gaseous precursor such as ammonia (NH₃), which can be provided directly as a gas or indirectly through the decomposition of a solid species). In the prior art, all known syntheses used either phosphorus oxynitride (PON) or ammonia (NH₃) gas as a nitrogen source, and included either APO₃ (A=Na, K) and/or phosphorus oxynitride (PON) as a phosphorus source. A traditional solid state method includes mixing (by grinding or using a vibratory ball mill) stoichiometric amounts of a metal oxide and either a metaphosphate (e.g., sodium metaphosphate, NaPO₃) or phosphorus oxynitride (PON) as well as optionally adding ammonium phosphate (NH₄H₂PO₄) or metal phosphate AₓPO₄ (e.g. Na₃PO₄, FePO₄) precursors to balance the stoichiometry, and heating the mixture to about 600° C. to 800° C. for about a day under flowing ammonia (NH₃) gas in a tube furnace.

The disclosed more effective method for synthesizing substantially pure nitridophosphate compound(s) of formula (3) based on solid state methodology, including a Pechini-type method, relies on adding urea (CH₄N₂O) in a preferred embodiment or any another precursor (e.g., melamine) which decomposes to release NH₃ locally to the mixture of reactants. The method generally includes (1) mixing stoichiometric amounts of metal oxide, a metaphosphate, and urea, (2) heating the mixture under flowing ammonia gas to about 350° C. at a rate of about 300° C./hour, and (3) heating the mixture to about 700 to 800° C. under flowing ammonia. In a preferred embodiment, the mixing of stoichiometric amounts of metal oxide, a metaphosphate, and urea can be accomplished by grinding or by using a vibratory ball mill. The urea typically has a mole fraction of 10-90% of the starting mixture, with a most preferred embodiment of 33 mole %. Depending on the selection of the metal starting material, phosphorus source, and nitrogen source, the time and temperature of the reaction may be adjusted accordingly without departing from the scope and spirit of the invention. Preferably, the reaction temperatures range from 500-900° C.

Another embodiment is directed to a method for synthesizing substantially pure nitridophosphate compound(s) of formula (3) based on a solid state synthesis utilizing a phosphorus source other than PON or NaPO₃. The method generally has the steps of (1) mixing stoichiometric amounts of metal oxide, e.g., Fe₂O₃, sodium acetate (NaOCH₂CH₃), and diammonium hydrogen phosphate [(NH₄)₂HPO₄] together, preferably at Na:M:P molar ratio of 2:2:3; (2) heating the mixture to about 350° C., and (3) heating the mixture to about 600° C. under flowing ammonia. The mixture is preferably ball milled prior to each step of heating. Depending on the selection of the metal starting material, phosphorus source, and nitrogen source, the time and temperature of the reaction may be adjusted accordingly without departing from the scope and spirit of the invention. For example, in synthesizing Na₂Fe₂(PO₃)₃N, iron oxide (Fe₂O₃), sodium acetate (NaOCH₂CH₃), and diammonium hydrogen phosphate [(NH₄)₂HPO₄] are mixed together in a Na:Fe:P molar ratio of 2:2:3 by either grinding or vibratory ball milling and heated at about 350° C. for about 8 hours. The mixture is preferably ground again and heated at 600° C. for 20 hours under flowing ammonia (NH₃) gas. It is believed that this method offers advantages in terms of the reaction time, reaction temperature, and product particle size.

Yet another embodiment is directed to a method for synthesizing substantially pure nitridophosphate compound(s) of formula (3) based a polymer complex method (or Pechini-type method). The method generally involves (1) dissolving stoichiometric amounts of sodium metaphosphate, metal ammonia, e.g., ammonium vanadate, citric acid and urea in water, preferably at a molar ratio of 3:1:2:1; (2) heating the solution at about 60-90° C. for 1 to 10 hours, (3) drying the resulting solution to obtain a dried gel; (4) grinding or ball-milling the dried gel; (5) heating the dried gel to about 400° C. in air for about 10-20 hours; (6) heating the resulting material at about 600-800° C. for about 10-20 hours under flowing ammonia gas. Based on the selection of the transition metals, the method can be modified to accommodate appropriate duration and temperature in order to produce the desired nitridophosphate.

Another embodiment is directed to a method of forming the nitridophosphate compounds of formula (16). The method generally involves converting (at least partially) sodium in the compounds of formulas (5)-(11) into lithium through ion-exchange. To propagate the conversion various ion-exchange agents can be used, such as (i) LiBr in acetonitrile, (ii) a eutectic mixture of LiNO₃/LiCl, or (iii) a large excess of LiBr or LiCl. The use of LiBr in acetonitrile as an ion-exchange agent is especially suitable for nitridophosphate compound of formula (16) where M is Ti due to the higher sodium-ion mobility at moderate temperature. To accelerate the ion-exchange process, the ion-exchange agent alone, the nitridophosphate compound with sodium ion therein, or a combination of the ion-exchange agent and the nitridophosphate compound can be heated up. In one exemplary embodiment, if the ion-exchange agent is the eutectic mixture of LiNO₃/LiCl, the mixture can be heated up to the melting point of the salt mixture. In another exemplary embodiment, if the ion-exchange agent is the large excess of LiBr or LiCl, the mixture of nitridophosphate and LiBr/LiCl can be heated up to around 200-400° C. (e.g., about 300° C.) for 10 to 20 hours. In some embodiments, it may be necessary to repeat the ion exchange process for several cycles, preferably 2 to 4, in order to obtain complete exchange of sodium with lithium.

While the cubic ionic conductor materials, primarily nitridophosphate materials, the electrodes and the electrochemical cells based on such materials have been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims.

### EXAMPLES

### Example 1

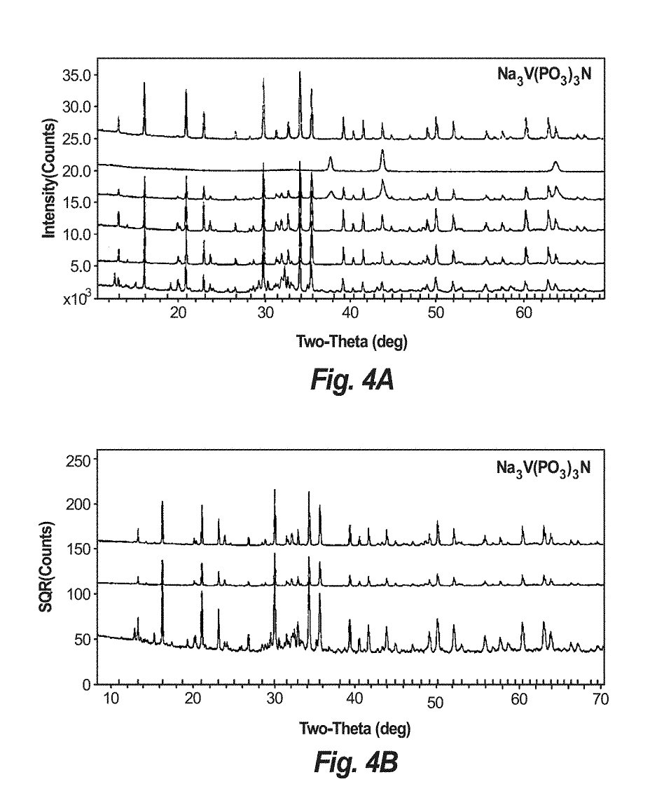

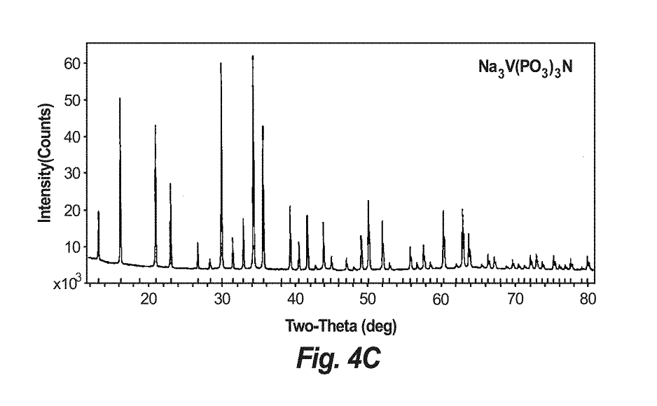

This example illustrates the synthesis of Na₃V(PO₃)₃N using the conventional solid state synthesis method of prior art. Sodium metaphosphate, NaPO₃, (Fisher Scientific, 99.0%) was milled with vanadium oxide, V₂O₅, (Alfa Aesar, 99.9%) in a vibratory ball mill for 90 minutes in a Na:V molar ratio of 3:1. The mixture was heated at 350° C./hour up to 850° C., and reacted at that temperature for 20 hours in a tube furnace (Thermo Scientific Lindberg/Blue M Mini-Mite) under flowing NH₃ gas (see FIG. 4A (2-6)). The final product was identified by X-ray diffraction to primarily contain the cubic phase Na₃V(PO₃)₃N.

### Example 2

This example illustrates the synthesis of Na₃V(PO₃)₃N. Sodium metaphosphate, NaPO₃, was ball-milled with vanadium oxide, V₂O₅, and urea, CO(NH₂)₂, for 90 minutes in a Na:V:urea molar ratio of 3:1:2. The temperature of the mixture was raised at a rate of about 350° C./hour up to about 700° C. and heated at 700° C. for 25 hours, 20 hours, or 12 hours in a tube furnace under flowing NH₃ gas (see FIG. 4B). The final product was identified by X-ray diffraction to primarily contain the cubic phase Na₃V(PO₃)₃N.

### Example 3

This example illustrates the synthesis of Na₃V(PO₃)₃N. Sodium metaphosphate, NaPO₃, was ball-milled with vanadium oxide, V₂O₅, and urea, CO(NH₂)₂, for 90 minutes in a Na:V:urea molar ratio of 3:1:2. The mixture was heated at 300° C./hour up to about 350° C. and held at that temperature for 5 hours in a tube furnace under flowing NH₃ gas. The reaction product was then reground and heated at 350° C./h up to about 700° C. for 20 hours in a tube furnace under flowing NH₃ gas, resulting in a product of higher purity than the products of Example 1 and Example 2. The final product was identified by X-ray diffraction.

### Example 4

This example illustrates the synthesis of Na₃V(PO₃)₃N using a solid state synthesis utilizing a phosphorus source other than PON or NaPO₃. The diammonium hydrogen phosphate [(NH₄)₂HPO₄] was mixed with vanadium oxide (V₂O₅) and sodium acetate at a molar ratio of 2:2:3 by vibratory ball milling with an ascorbic acid as an additive. The mixture was calcined at a temperature of 350° C. for 8 hours under flowing nitrogen (N₂) gas. The reaction product was further heated at 650° C. for 15 hours under flowing ammonia (NH₃) gas. The final product was identified by X-ray diffraction.

### Example 5

This example illustrates the synthesis of Na₃V(PO₃)₃N using a sol-gel method (Pechini-type). Sodium metaphosphate, (NaPO₃), ammonium vanadate (NH₄VO₃), citric acid, and urea were dissolved in 150 ml of water in the molar ratio of 3:1:2:1. This solution was stirred at 80° C. for about 5 hours. The obtained orange solution was further dried in a box furnace at 120° C. for 20 hours. The dried gel was then reground and heated to 400° C. in air for about 15 hours. The resulting material was heated at 650° C. for 15 hours in a tube furnace under flowing NH₃ gas to produce Na₃V(PO₃)₃N.

### Example 6

The X-ray diffraction patterns of the final products were collected in a theta-theta configuration using a Bruker D8 Advance diffractometer utilizing Cu Kα radiation and a 192 channel LynxEye position sensitive detector. The primary and secondary radii were set at 300 mm, and a variable divergence slit width of 12 mm was used.

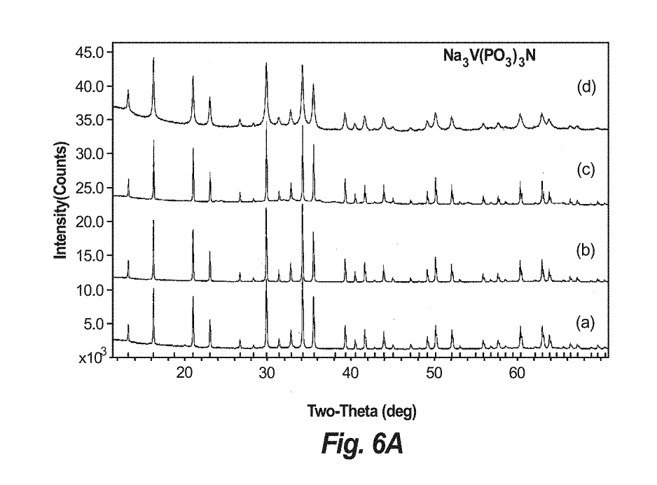

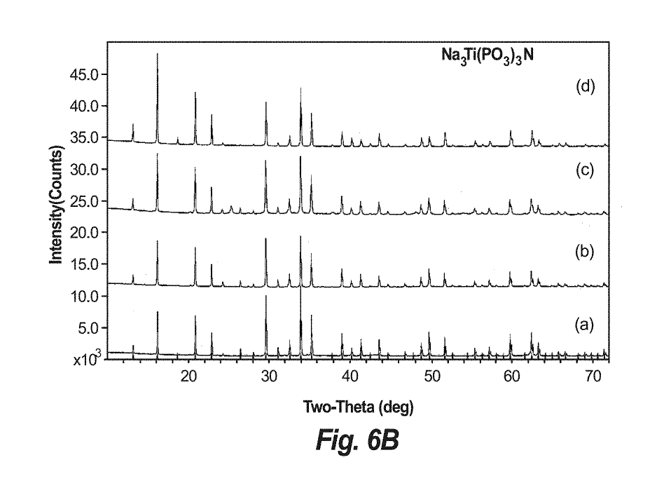

FIG. 6A is a plot of XRD patterns of Na₃V(PO₃)₃N synthesized by different methods, including (a) a conventional solid state synthesis at 700° C. for 20 hours (Example 1), (b) a solid state synthesis with urea added in an equimolar amount relative to vanadium and heating at 600° C. for 20 hours (Example 3); (c) a solid state synthesis that utilized sodium acetate and diammonium hydrogen phosphate starting materials and ascorbic acid as an additive, and heating at 650° C. for 15 hours (Example 4); and (d) a sol-gel method and heating at 650° C. for 15 hours (Example 5). The methods disclosed in Examples 3-5 appear to be superior to the convention method of Example 1.

Na₃V₂(PO₄)₃ was found to be the major impurity for products obtained from all synthesis conditions, although a small amount of unreacted V₂O₅ can also be found in the lowest temperature (600° C. and 700° C.) syntheses (see FIG. 4A). A rock salt phase (vanadium nitride or vanadium oxynitride) can be found above 800° C. and it becomes the only crystalline phase for the 850° C. sample. Sintering at 700° C. for 20 hours has been found to be an appropriate synthesis condition for this method according to the X-ray diffraction patterns shown in FIG. 4B.

The formation of Na₃V₂(PO₄)₃ during the thermal ammonolysis of NaPO₃ and V₂O₅ is likely due to the amount of oxygen in the starting materials exceeding the stoichiometric amount needed for the reaction, and the relatively slow solid state reaction rate than occurs due to the limited contact area between solid starting materials and the nitrogen source. Urea is a good nitrogen source which decomposes into NH₃ and HNCO at around 350° C. If urea is ball-milled with the starting materials (NaPO₃ and V₂O₅) and the mixture is gently heated to the synthesis temperature (600° C. to 700° C.), the decomposition products from urea can not only reduce the oxygen concentration around the starting materials, but can also increase its contact area with the nitrogen source. Including urea together with the NaPO₃ and V₂O₅ starting materials helped to reduce the fraction of Na₃V₂(PO₄)₃ in the final product, a result attributed to these effects. Another interesting result was that adding large amounts (typically a molar excess relative to the M transition metal) of urea to the starting materials can actually reduce the minimum required synthesis temperature to 600° C. However, in order to obtain phase pure Na₃V(PO₃)₃N, water washing is still useful to remove the tiny amorphous impurity (whose solubility suggests a Na-P-O phase) in the product obtained from this condition as is shown in FIG. 4C.

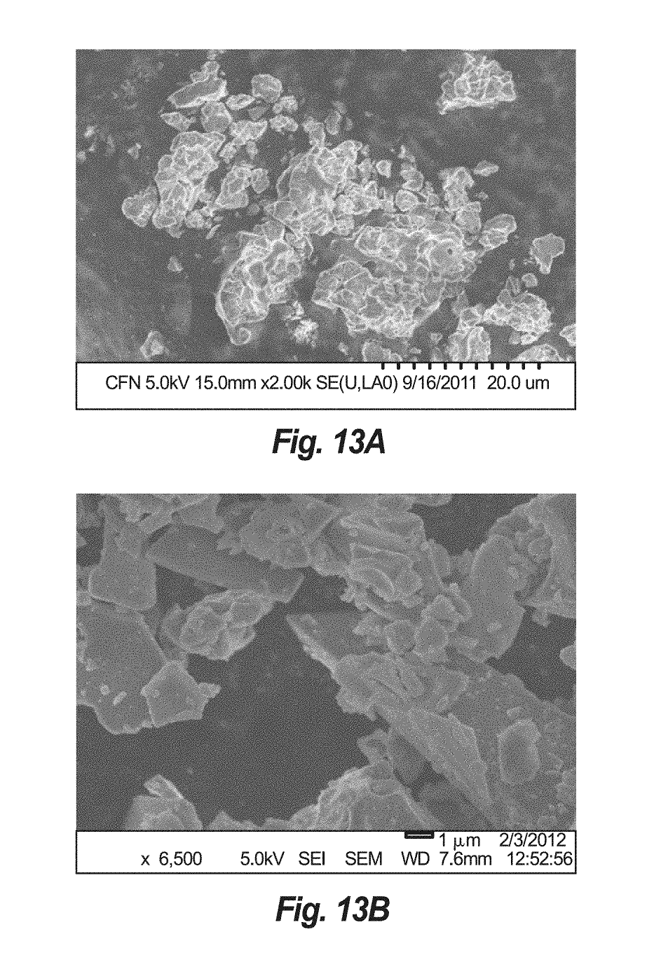

FIGS. 13A and 13B are the SEM images of the Na₃V(PO₃)₃N samples obtained from a conventional solid state synthetic route and obtained using Pechini method. The conventional synthesis produces large particles that are generally 1-10 microns (μ) in width. The ability of these particles to be electrochemically cycled to intercalate and de-intercalate both sodium and lithium ions indicates that this phase has a substantial ionic conductivity for Na and for Li even at room temperature. The reaction product of the Pechini method results in smaller particles (typically less than 3 microns in width, and less than one micron thick), which is expected to lead to improved performance in electrochemical devices due to the smaller diffusion distances required for both ions and electrons.

### Example 7

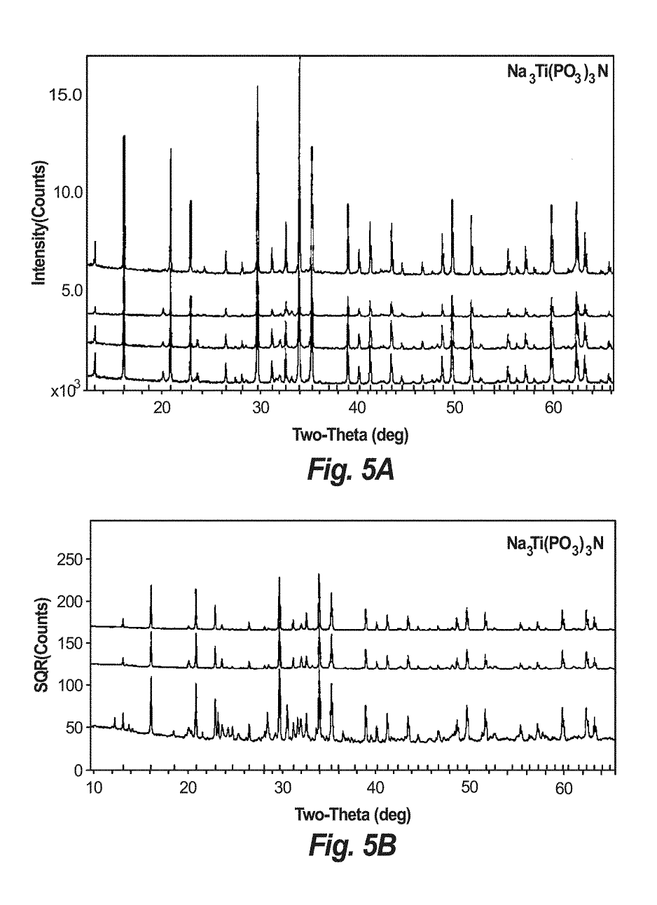

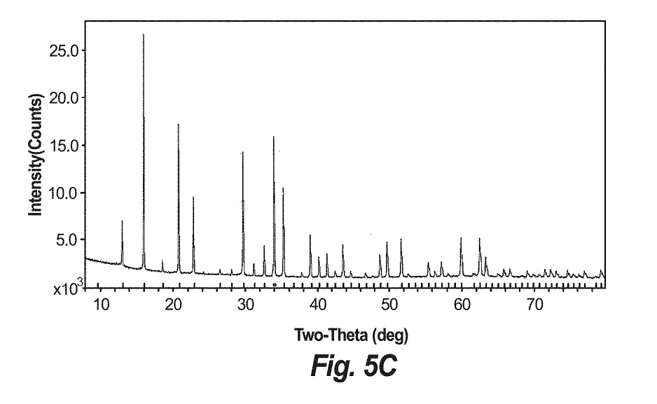

This example illustrates the synthesis of Na₃Ti(PO₃)₃N using a conventional solid state method. Sodium metaphosphate (Fisher Scientific, 99.0%) was ball-milled with titanium dioxide (either rutile or anatase form, Alfa Aesar, 99.5%)) for 90 minutes (min) in a Na:Ti molar ratio of 3:1. The mixture was heated at 350° C./h up to 800° C., and held at that temperature for 20 hours in a tube furnace under flowing NH₃ gas (see FIG. 5A). The final product was identified by X-ray diffraction to primarily contain the cubic phase Na₃Ti(PO₃)₃N.

### Example 8

This example illustrates the synthesis of Na₃Ti(PO₃)₃N. Sodium metaphosphate, NaPO₃, was ball-milled with TiO₂, and urea, CO(NH₂)₂, for 90 min in a Na:Ti:urea molar ratio of 3:1:2. The temperature of the mixture was raised at a rate of about 350° C./hour and heated at 750° C. for 25 hours, 20 hours, or 12 hours in a tube furnace under flowing NH₃ gas (see FIG. 5B). The final product was identified by X-ray diffraction to primarily contain the cubic phase Na₃Ti(PO₃)₃N.

### Example 9

This example illustrates the synthesis of Na₃Ti(PO₃)₃N. Sodium metaphosphate, titanium dioxide (either rutile or anatase), and urea were ball-milled together for 90 minutes in a Na:Ti:urea molar ratio of 3:1:2. The mixture was heated at 350° C./h up to 750° C. for 20 hours in a tube furnace under flowing NH₃ gas. The resulting product had higher purity than the products of Examples 5 and 6. The final product was identified by X-ray diffraction to primarily contain the cubic phase Na₃Ti(PO₃)₃N.

### Example 10

This example illustrates the synthesis of Na₃Ti(PO₃)₃N using a solid state synthesis utilizing a phosphorus source other than PON or NaPO₃. The diammonium hydrogen phosphate [(NH₄)₂HPO₄] was mixed with titanium oxide (TiO₂) and sodium acetate at a molar ratio of 2:2:3 by vibratory ball milling with an ascorbic acid as an additive. The mixture was calcined at a temperature of 350° C. for 8 hours under flowing of nitrogen (N₂) gas. The reaction product was further heated at 650° C. for 15 hours under flowing ammonia (NH₃) gas. The final product was identified by X-ray diffraction.

### Example 11

The structural characterization of the products from Examples 7-10 were investigated by X-ray diffraction and SEM imaging. The X-ray diffraction data was collected in a theta-theta configuration using a Bruker D8 Advance diffractometer using Cu Kα radiation. The X-ray diffraction patterns of final products are shown in FIG. 6B. Specifically, the plot shows the X-ray diffraction patterns of Na₃Ti(PO₃)₃N synthesized by different methods, including (a) a conventional solid state synthesis at 750° C. for 20 hours (see Example 7), (b) a solid state synthesis with urea added in an equimolar amount relative to titanium and heating at 700° C. for 20 hours (see Example 9), (c) a solid state synthesis that utilized sodium acetate and diammonium hydrogen phosphate starting materials and ascorbic acid as an additive, and heating at 650° C. for 15 hours (see Example 10). Pattern (d) is the partially desodiated sample, Na₃,Ti(PO₃)₃N with x ˜0.6, that resulted from washing the product of the conventional solid state reaction with diluted HCl (1:10), and which exhibits a prominent 002 peak at around 18 degrees two-theta.

The major impurity is found to be NASICON-type Na₃Ti₂(PO₄)₃. It was possible to eliminate Na₃Ti₂(PO₄)₃ as an impurity in the final product by washing with dilute hydrochloride acid (1:10 by volume) solution. FIG. 5C shows the X-ray diffraction pattern of the diluted HCl-washed Na₃Ti(PO₃)₃N sample, which can be indexed in a simple cubic phase with the cell parameter around 9.514 Å.

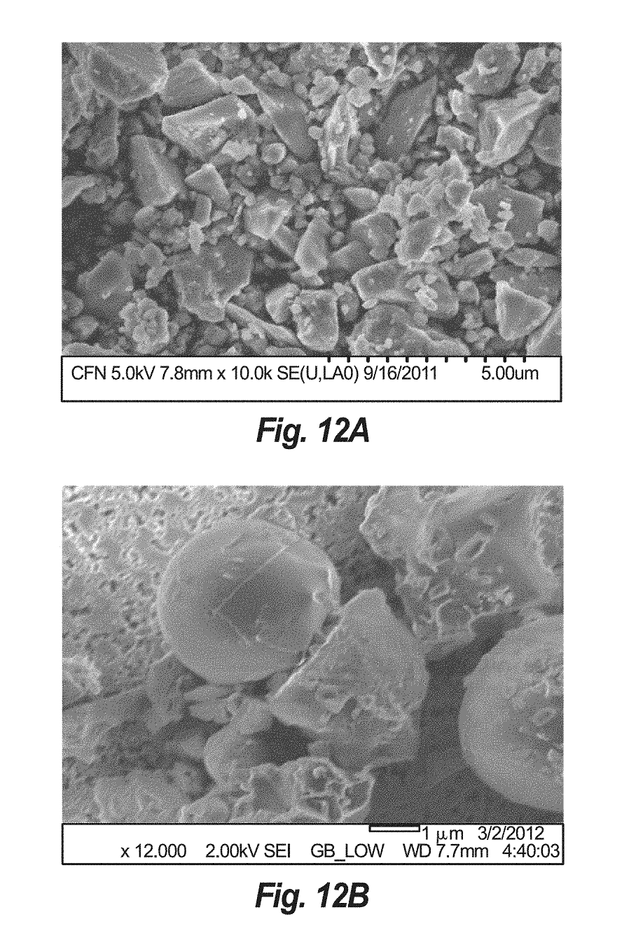

FIG. 12A illustrates an SEM image of the Na₃Ti(PO₃)₃N sample obtained from the conventional solid state reaction (750° C., 20 hours, flowing. NH₃) of NaPO₃ and TiO₂ (rutile, micrometer particles) starting materials. In contrast, FIG. 12B illustrates the SEM image of the Na₃Ti(PO₃)₃N sample obtained by reacting (650° C., 15 hours, flowing NH₃) the starting materials of Na(CH₃COO), (NH4)₂HPO₄, and TiO₂ (rutile, <32 nm particle). Relatively large (1-5 micron width), faceted particles are obtained by the conventional solid state reaction route. With the acetate precursor, smaller spherical particles about 1 micron in diameter are the primary reaction product. The smaller size of these particles is expected to enhance the rate performance of samples prepared in this manner.

### Example 12

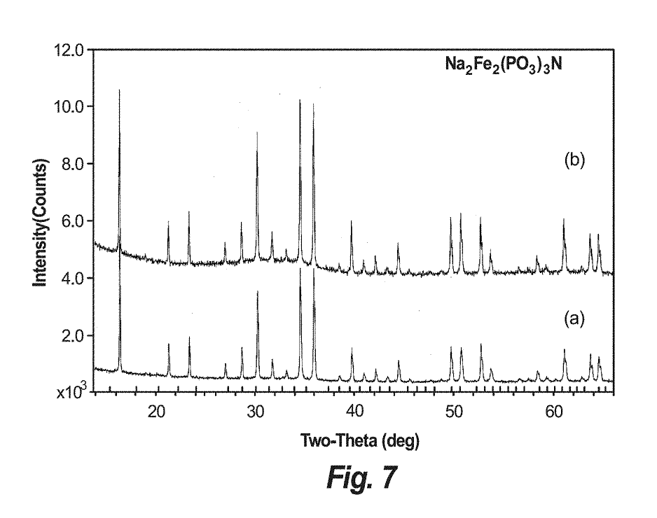

This example illustrates the synthesis of Na₂Fe₂(PO₃)₃N using a conventional solid state method. Sodium metaphosphate (Fisher Scientific, 99.0%) was ball-milled with ferric iron oxide (Fe₂O₃) (Alfa Aesar) for 90 min in a Na:Fe molar ratio of 1:1. The mixture was heated at 350° C./h up to 600° C., and held at that temperature for 20 hours in a tube furnace under flowing NH₃ gas. The fmal product was identified by X-ray diffraction to primarily contain the cubic phase Na₂Fe₂(PO₃)₃N (see FIG. 7(a)).

### Example 13

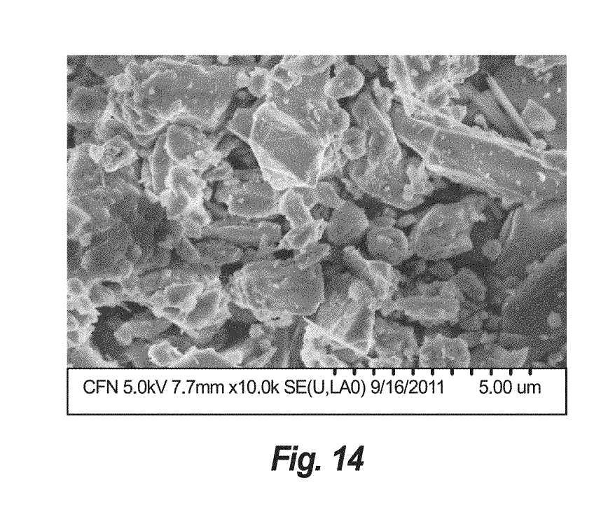

This example illustrates the synthesis of Na₂Fe₂(PO₃)₃N. Sodium metaphosphate, ferric iron oxide, Fe₂O₃, and diammonium phosphate, (NH₄)₂HPO₄, were ball-milled together for 90 min in a Na:Fe:diammonium phosphate molar ratio of 2:2:1. The mixture was heated at 300° C./hour up to 350° C. and held there for 5 hours in a tube furnace under flowing NH₃ gas. The product was then heated at 300° C./h up to 600° C. and reacted at that temperature for 20 hours in a tube furnace under flowing NH₃ gas. The final product was identified by X-ray diffraction to primarily contain the cubic phase Na₂Fe₂(PO₃)₃N (see FIG. 7(b)). FIG. 14 shows the SEM image of the obtained Na₂Fe₂(PO₃)₃N.

### Example 14

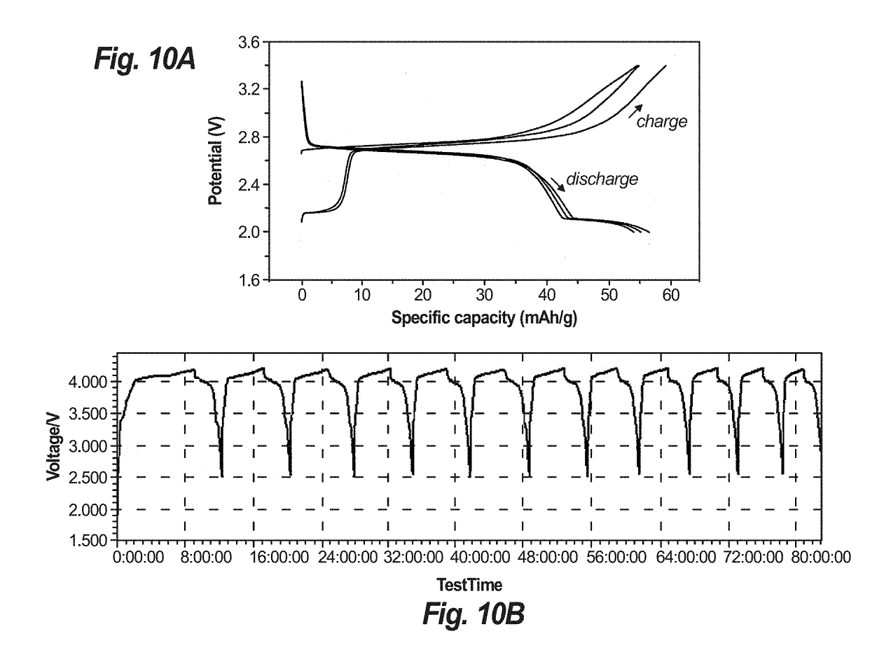

This example illustrates a production of a battery with Na₃V(PO₃)₃N as a cathode. The reaction product from Example 3 was ball-milled with carbon black in an 8:1 weight ratio. This mixture was then combined with PVDF (polyvinylidene fluoride) in a 9:1 weight ratio. An appropriate amount of NMP (N-Methyl-2-Pyrrolidone) was added to the mixture as the solvent to form a thick slurry. The slurry was then painted on an aluminum (Al) foil, with a thickness of about 5 μm and a loading of about 2-3 mg/cm², and the whole foil was dried in a vacuum oven at 80° C. for about 12 hours. After that, the dried foil was cut into several round electrodes with the area of about 0.806 cm² /each. The cycling performance was evaluated inside 2032-type coin cells, using lithium metal as the anode and a commercial Samsung electrolyte (1M LiPF₆ in ethylene carbonate/dimethyl carbonate solution). The cycling was carried out between 2.0 V and 5.0 V (versus Li⁺/Li) at a current density of 0.045 mA/cm² (a rate of about C/8) as shown in FIG. 9. The cycling performance of a sodium-ion battery made with a Na₃V(PO₃)₃N cathode and a Na metal anode which was measured between 2.5 V and 4.2V at a current density of 0.020 mA/cm² (a rate of about C/20) as shown in FIG. 10B.

### Example 15

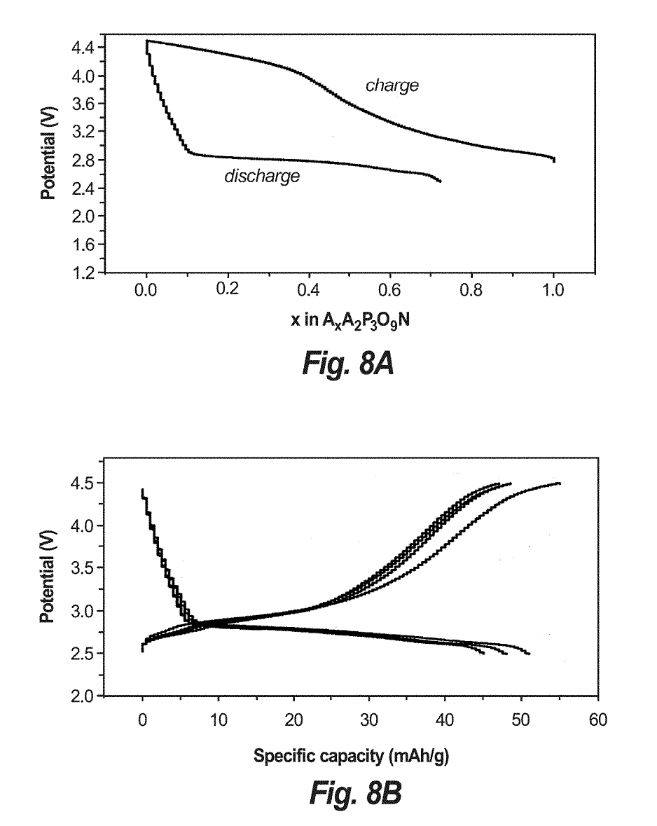

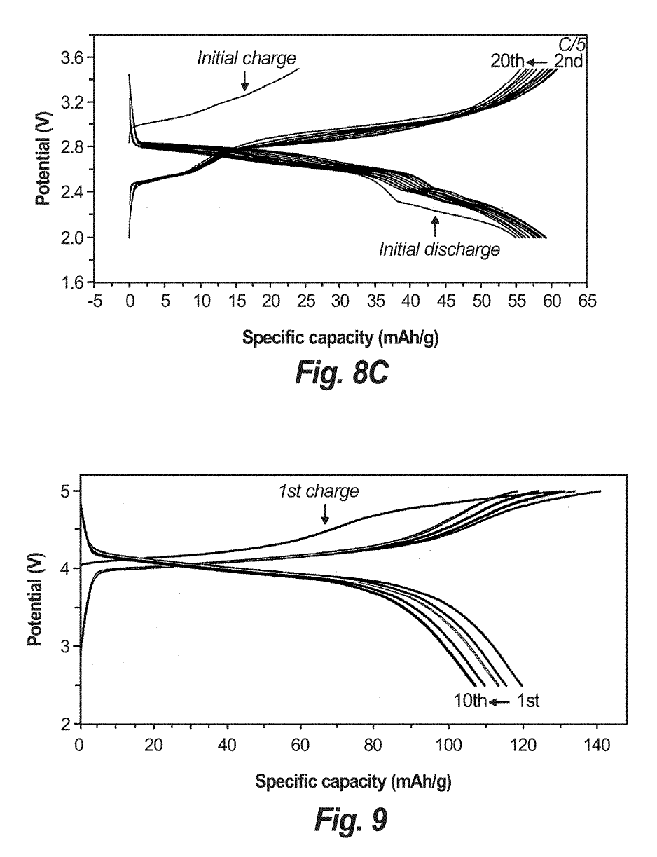

This example illustrates a production of a battery with Na₃Ti(PO₃)₃N as a cathode. The reaction product from Example 9 was ball-milled with carbon black and graphite in a 16:1:1 weight ratio. This mixture was then mixed with PVDF (polyvinylidene fluoride) in a 9:1 weight ratio. A minimal amount of NMP (N-Methyl-2-Pyrrolidone) was added to the mixture as the solvent to form a slurry. The slurry was then painted on an Al foil, with a thickness of about 10 μm, and the whole foil was dried in a vacuum drying oven at 80° C. for 10 hours. After that, the dried foil was cut into several round electrodes with the area of about 0.806 cm² /each. The cycling performance was evaluated inside 2032-type coin cells, using lithium metal as the anode and a commercial Samsung electrolyte (1M LiPF₆ in ethylene carbonate/dimethyl carbonate solution). The cycling was carried out between 2.0 V and 4.5 V at room temperature at a C/10 rate as shown in FIG. 8. The cycling performance of a sodium-ion battery made with a Na₃Ti(PO₃)₃N cathode and a Na metal anode which was measured between 2.0 V and 3.5V at a C/10 rate as shown in FIG. 10A.

### Example 16

Cycling performance of a vanadium nitridophosphate battery made according to Example 14 is shown in FIG. 9. The cycling was carried out at a C/8 rate (charging or discharging of the theoretical capacity in 8 hours) between 2.5 V and 5 V. FIG. 9 shows that the battery has a large initial storage capacity which persists over a number of cycles. In the first charge cycle, Na is removed from the compound leaving a material with an approximate composition of Na₁V(PO₃)₃N. In the first discharge cycle, Li is intercalated into this compound giving an approximate final composition of Na₁Li₂V(PO₃)₃N, and a composition during cycling which can be generically described as Na₃₋ₓLiₓV(PO₃)₃N (0<x<2). The observed charge storage capacity of this material is as large as 120-140 mAh/g [essentially achieving its theoretical capacity of 145 mAh/g, calculated with respect to the starting composition of Na₃V(PO₃)₃N)], while the working potential of the battery is about 4.1 V. The actual gravimetric energy density of this compound is about the same as LiFePO₄ when cycled against a Li or C anode. It is believed, however, that this nitridophosphate should exceed the gravimetric energy density of LiFePO₄ when cycled against a higher potential anode such as Li₄Ti₅O₁₂.

### Example 17

Cycling performance of a titanium nitridophosphate battery made according to Example 15 is shown in FIG. 8, having a substantial initial storage capacity which persists over a number of cycles. In the first charge cycle illustrated in FIG. 8A, Na is removed from the compound leaving a material with an approximate composition of Na₂Ti(PO₃)₃N. In the first discharge cycle, Li is intercalated into this compound giving an approximate final composition of Na₂Li₁Ti(PO₃)₃N. As shown in FIG. 8B the capacity is slowly decreasing over the first three charge-discharge cycles. However, the cycle life performance over 20 cycles shows good capacity retention as illustrated in FIG. 8C. Electrochemical features below ˜2.5V are primarily due to a NASICON-type minority phase of Na₃V₂(PO₄)₃.

The composition during cycling can be generically described as Na₃₋ₓLiₓTi(PO₃)₃N (0<x<1). The observed Li charge storage capacity of this material is typically 50-70 mAh/g, which is close to its ideal theoretical capacity of 73 mAh/g [calculated with reference to the initial formula of Na₃Ti(PO₃)₃N)], while the working potential of the battery is about 2.8 V.

### Example 18

X-ray powder diffraction data of the Na₃Ti(PO₃)₃N sample from Example 9 was collected at the X7B beam line (λ=0.3184 Å) at the NSLS (National Synchrotron Light Source, Brookhaven National Laboratory, Upton, N.Y.), and the crystal structure was refined based on this data. A powder sample was loaded into a 0.5 mm capillary, diffraction data was collected on the 2D area detector at this beam line. Rietveld refinement was carried out on the collected X-ray diffraction data using the previously published single crystal structure of Na₃Ti(PO₃)₃N as the starting point of the refinement (Vitalij K. et al. “Fundamentals of Powder Diffraction and Structural Characterization of Materials”. Springer Press, 2005; incorporated herein by reference). The refined crystal structure confirms the expected cubic non-centrosymmetric structure with the space group of P2₁3, and that the N(PO₃)₃⁶⁻ anion in these compounds is formed by three PO₃N tetrahedral sharing one N vertex. These anions are connected to TiO₆ octahedral through an O vertex. There are three different sodium sites in the structure which are fully occupied.

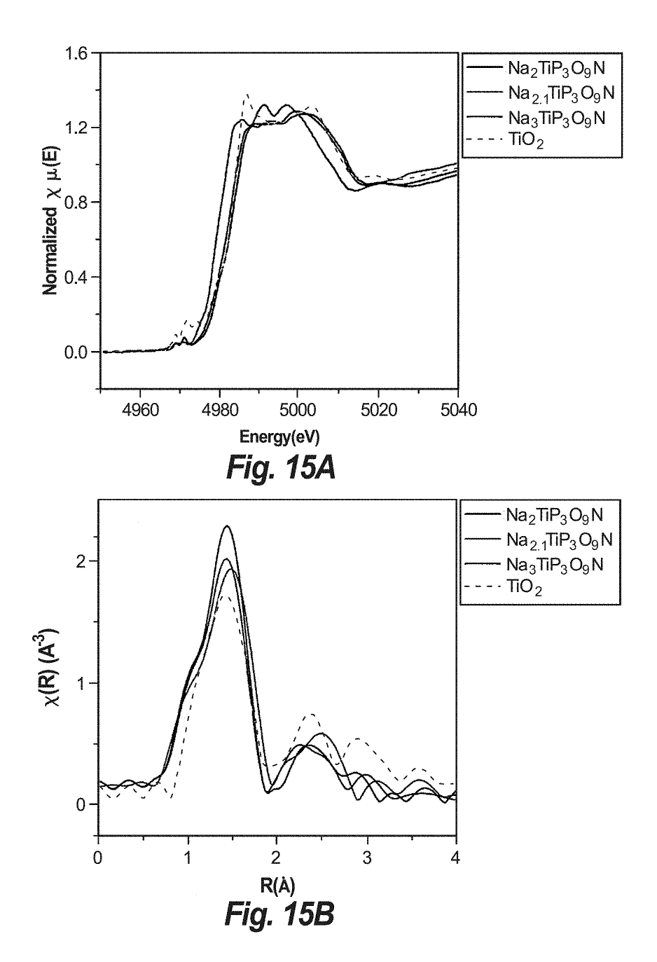

A sample from Example 11 was also studied using synchrotron diffraction techniques. This material was found to have the same crystal structure but a composition which was sodium deficient as the refined formula was Na₃₋ₓTi(PO₃)₃N with x=0.4. X-ray absorption data also provide evidences for the sodium deficiency in the sample based on the shift of the titanium edge, confirming that this sodium can be extracted from this nitridophosphate structure type, as shown in FIG. 15A and FIG. 15B. It is believed that the wash with dilute HCl resulted in the extraction of Na from Na₃Ti(PO₃)₃N that was originally stoichiometric, as the Cl anion is a mild oxidant.

### Example 19

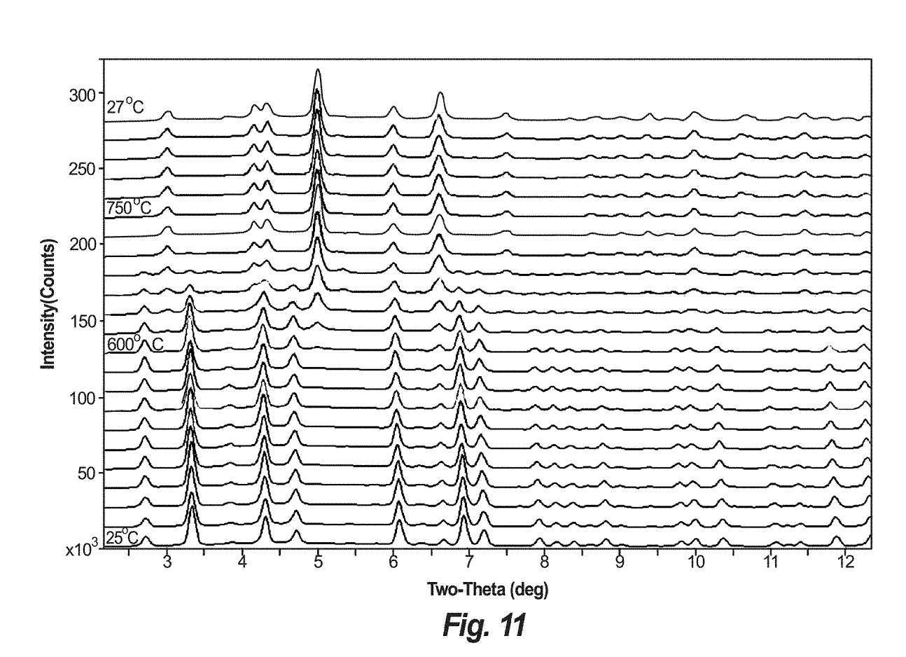

An in-situ X-ray diffraction study of Na₃Ti(PO₃)₃N can provide useful information on the thermal stability, phase transformation processes, sodium deficiency, and sodium mobility over a wide range of temperatures. The in-situ X-ray diffraction patterns Were collected at X-7B beam line at NSLS with the wavelength of 0.3196 Å. The experiment was carried out between 25° C. and 850° C. with temperature increasing at a rate of 2° C./min. After heating at 850° C. for half an hour, the sample was then cooled down to room temperature. FIG. 11 shows the in-situ XRD patterns of the heating process of Na₃₋ₓTi(PO₃)₃N in the air. The formation of an oxidized phase above 600° C. is evident from the phase transition by which the nitridophosphate with P2₁3 symmetry was converted to NASICON-type Na₃Ti₂(PO4)₃ with R-3 symmetry as temperature changes from 600° C. to 750° C. This is a relatively high phase transition temperature for a battery cathode material, and indicates a good potential for stable and safe long term operation.

### Example 20

The crystal structure of Na₃V(PO₃)₃N was determined using synchrotron X-ray diffraction data. X-ray diffraction data was collected at X-14A beam line (λ=0.7717 Å) with a 1D PSD detector at the NSLS. A powder sample was loaded into a 0.5 mm capillary and was spun at about 5000 rpm to reduce preferred orientation effects. The Rietveld refinement on this data was carried out using the TOPAS program with a pseudo-Voigt type peak shape. The single crystal structure of Na₃Ti(PO₃)₃N was chosen as the starting model in this refinement. Similar to the structure of Na₃Ti(PO₃)₃N, three different sodium sites can be found in the structure of Na₃V(PO₃)₃N. All of them sit at separate 4a symmetry sites and have significantly different B-factors, which perhaps indicates a different sodium binding energy and mobility for the different sites.

The vanadium valence in Na₃V(PO₃)₃N were probed using XANES data collected at the X-19A beam line at the NSLS. The edge position of Na₃V(PO₃)₃N is found at a much lower energy area than V₂O₄ (ΔE>2 eV), confidently demonstrating that the oxidation state of vanadium in the as-prepared sample is substantially lower than +4. Since the absorption edge curves of Na₃V(PO₃)₃N and V₂O₃ cross, it is difficult to know whether the oxidation state of vanadium in Na₃V(PO₃)₃N is higher or lower than +3, but it is certainly near +3.

### Example 21

This example illustrates the preparation of the vanadium based nitridophosphate that can accommodate excess mobile cations. The starting materials NaPO₃ (Fisher Scientific, n ˜6), V₂O₅ (Alfa Aesar, 99.6%) and urea were ball milled for 120 min in the molar ratio of 3.05:0.5:2. Alternatively, the starting materials were ball milled for 120 minutes at the molar ratio of 3:1:2. The compound Na₃VP₃O₉N could be produced by heating this mixture to temperatures in the range of 600° C. to 800° C. and holding until the reaction was complete (typically 10-20 hrs). The final product was identified by X-ray diffraction to primarily contain the cubic phase Na₃V(PO₃)₃N.

### Example 22

This example illustrates a production of a 2032-type coin cell battery with Na₃V(PO₃)₃N as a cathode. The powdered reaction product from Example 21 was ball milled with carbon black (acetylene black) in a mass ratio of 8:1 for 3 hours. PVDF (polyvinylidene difluoride) was then added into the mixture in a 1:9 weight ratio. An appropriate amount of NMP (1-Methyl-2-pyrrolidinone) was added as a solvent to the well mixed powder to form a thick slurry. The slurry was then casted on an Al foil with the thickness of about 5 μm. The foil was then dried in a vacuum oven at 80° C. for 12 hours. After that, the dried foil was cut into several disc shape electrodes with the area of about 0.8 cm2/each, and a typical active material loading of 5-6 mg/cm². A 2032-type coin cell battery was assembled in an Ar (Argon) filled glove box. In addition to the cathode film, 1M LiPF₆ dissolved in EC/DMC with a 1:2 mass ratio (ethylene carbonate/dimethyl carbonate) was used as electrolyte and a lithium metal foil was used as the anode. The galvanostatic cycling of Na₃VP₃O₉N/Li battery was carried out on an Arbin BTU-2000 cycler between 1.0 V and 4.9 V (versus Li⁺/Li) at a C/36 rate, corresponding to 0.045 mA/cm².

### Example 23

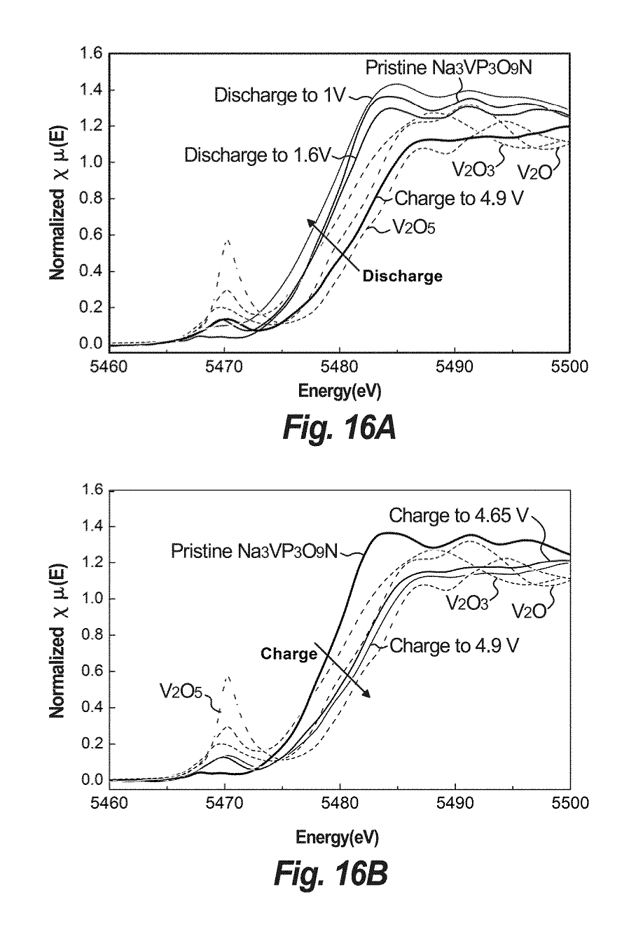

The reduction of vanadium in the Na₃VP₃O₉N compound produced in Example 21 has been confirmed by in situ XANES (X-ray absorption near edge spectroscopy) data which can probe the valence state of vanadium (V). As shown in FIG. 16A, vanadium starts in a 3+ oxidation state in pristine Na₃VP₃O₉N, and then is oxidized during charging to a valence near 5+ at the end of charging (Scan 29) compared to reference compounds for V³⁺ (V₂O₃), V⁴⁻ (VO₂), and V⁵⁺ (V₂O₅). On the subsequent discharge shown in FIG. 16B, V is reduced and by the end of discharge (Scan 55) the V oxidation state has been reduced below the 3+ state when compared to both the pristine compound and the V₂O₃ reference.

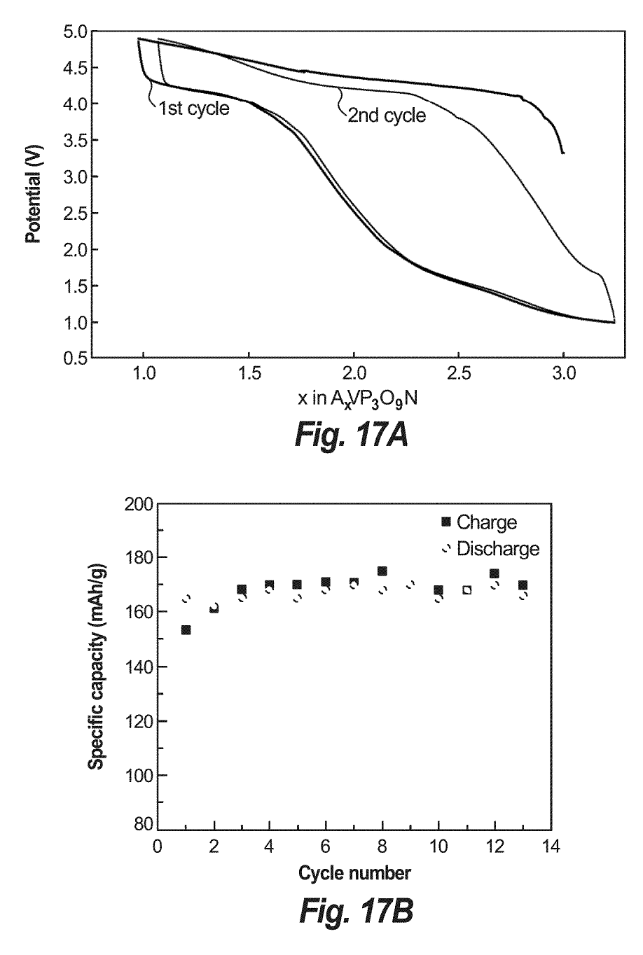

The ability of the structural framework to accept excess mobile cations can also been seen in the electrochemical cycling data of batteries constructed with a Na₃VP₃O₉N cathode, a Li metal anode, and a Li ion electrolyte. As illustrated in FIG. 17A, the gravimetric capacity of the cathode during the initial charge, where Na ions are removed, is measured to be 140 mAh/g. This value is close to the theoretical capacity of 144 mA/g of the pristine material expected when only vanadium oxidation (V³⁺⇄V⁵⁺) occurs. The measured capacity during the first discharge is 165 mAh/g, exceeding the 144 mA/g theoretical capacity of Na₃VP₃O₉N for the V⁵⁺⇄V³⁺ reduction processes. This excess capacity is retained in subsequent cycles as shown in FIG. 17B. Without being bound by theory, it is believed that this excess capacity occurs due to the insertion of excess Li⁺ ions (which are small), rather than the insertion of Na⁺ ions (which are larger). In some embodiments, the conditions may exist for the insertion of excess Na⁺ ions, for instance, within the larger structural framework, such as K₃M^{III}P₃O₉N compounds that are expanded due to the very large size of K⁺ ions. The ability to insert excess ions demonstrates that substantially larger gravimetric capacities can be accomplished with the present method than in a typical stoichiometric exchange. It is believed that this excess capacity will most likely occur at Voltages suitable for battery anodes, enhancing the suitability of this system for applications such as symmetric batteries, or as epitaxial thin film batteries.

### Example 24

This example illustrates the synthesis of Na₃AlP₃O₉N. Sodium metaphosphate (Fisher scientific, 99.0%) was ball-milled with Al₂O₃ (Alfa Aesar, 99.0%) for 90 minutes at a molar ratio of 6:1. The mixture was heated at the rate of 100° C./h up to 775° C. and maintained at that temperature for 20 hours in a tube furnace under a flow of ammonium gas. The final product was identified by x-ray diffraction to primarily contain the cubic phase Na₃Al(PO₃)₃N.

### Example 25

Similarly to Example 21, Na₂Mg₂P₃O₉N was synthesized by ball-milling sodium metaphosphate with magnesium oxide (MgO) (Alfa Aesar, 99.5%) and ammonium phosphate (90%; dibasic) for 90 minutes at a molar ratio of 2:2:1. The mixture was heated at the rate of 100° C./h up to 800° C. and maintained at that temperature for 20 hours in a tube furnace under a flow of ammonium gas. The final product was identified by x-ray diffraction to contain the cubic phase Na₂Mg₂(PO₃)₃N.

### Example 26

This example illustrates the synthesis of Li₃AlP₃O₉N. Na₃AlP₃O₉N of Example 23 and LiBr were mixed in a molar ratio of 1:10. The mixture was heated up to 320° C. for 20 hours in a tube furnace under a flow of N₂ gas. The product was washed with methanol and then mixed with another batch of fresh LiBr in the same molar ratio. This process was repeated 3 times. The final product was identified by X-ray diffraction to contain a cubic phase with lattice parameter of about 8.9 Å. This phase was identified to be Li₃AlP₃O₉N.

### Example 27

This example illustrates the synthesis of Li₃₋ₓNaₓAlP₃O₉N. Na₃AlP₃O₉N of Example 24 and a eutectic mixture of LiNO₃/LiCl were mixed at a molar ratio of 1:10. The mixture was heated up to about 290° C. for about 10 h in a tube furnace under a flow of nitrogen gas. The product was washed with water and phosphoric acid and then mixed with another batch of fresh LiNO₃/LiCl in the same molar ratio as before. This process was repeated 2 times. The final product was identified by X-ray diffraction to contain a cubic phase with lattice parameter about 9.0 Å. This phase was identified to be Li₃₋ₓNaₓAlP₃O₉N.

### Example 28

This example illustrates the synthesis of Li₃V(PO₃)₃N. Na₃VP₃O₉N of Example 1 and LiBr were mixed in a molar ratio of 1:10. The mixture was heated up to about 320° C. for about 20 hours in a tube furnace under a flow of nitrogen gas. The product was washed with methanol and then mixed with another batch of fresh LiBr in the same molar ratio as before. This process was repeated 4 times. The final product was identified by X-ray diffraction and was found to contain a cubic phase with lattice parameter about 9.15 Å. This phase was identified to be Li₃VP₃O₉N.

### Example 29

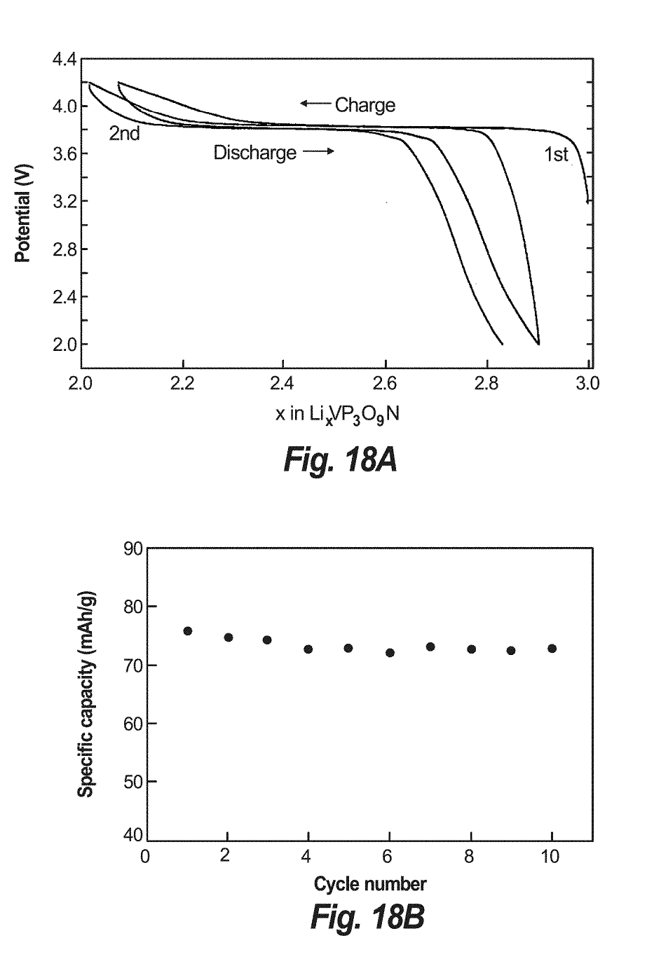

This example illustrates a production of a battery with Li₃VP₃O₉N as a cathode. The reaction product from Example 28 was mixed with carbon black and PVDF (polyvinylidene fluoride) in a 6:3:1 weight ratio. A minimal amount of NMP (N-Methyl-2-Pyrrolidone) was added to the mixture as the solvent to form a thick slurry. The slurry was then painted on an aluminum (Al) foil, with a thickness of about 5 μm, and the whole foil was dried in a vacuum oven at 80° C. for about 6 hours. After that, the dried foil was cut into several round electrodes with the area of about 0.806 cm²/each. The cycling performance was evaluated inside of 2032-type coin cells, using lithium metal as the anode and commercial Samsung electrolyte (1M LiPF₆ in ethylene carbonate/dimethyl carbonate solution) the electrolyte. The cycling was carried out between 2.0 V and 4.2 V (versus Li⁺/Li) at room temperature at a C/15 rate, corresponding to 0.02 mA/cm². FIG. 18A shows the first and second charge-discharge profiles of Li₃VP₃O₉N cycled against Li⁺/Li between 2 V and 4.2 V at C/15. The electrochemical active potential was found to be centered at about 3.8 V. A lithium ion can be reversibly cycled within the structure within this voltage window, corresponding to a specific capacity of about 73 mAh/g as illustrated in FIG. 18B.

### Example 30

This example illustrates the synthesis of Li₂₊ₓTiP₃O₉N. Na₃TiP₃O₉N of Example 7 and LiBr were mixed in a molar ratio of 1:10. The mixture was heated up to about 320° C. for about 20 hours in a tube furnace under a flow of N₂ gas. The product was washed with methanol and then mixed with another batch of fresh LiBr in the same molar ratio. This process was repeated 3 times. The final product was identified by X-ray diffraction to contain a cubic phase with lattice parameter about 9.30 Å. This phase was identified to be Li₂₊TiP₃O₉N.

### Example 31

This example illustrates the synthesis of Li₂₊ₓTiP₃O₉N. Na₃TiP₃O₉N of Example 7 (0.005 mol) was mixed with LiBr in acetonitrile solution (1 M, 20 ml), the mixture was sealed in a glass vial in a glove box and then heated up to about 75° C. for 5 days. The product was washed with acetonitrile and methanol several times. The final product was identified by X-ray diffraction to contain a cubic phase with lattice parameter about 9.30 Å. This phase was identified to be Li₂₊ₓTiP₃O₉N.

### Example 32

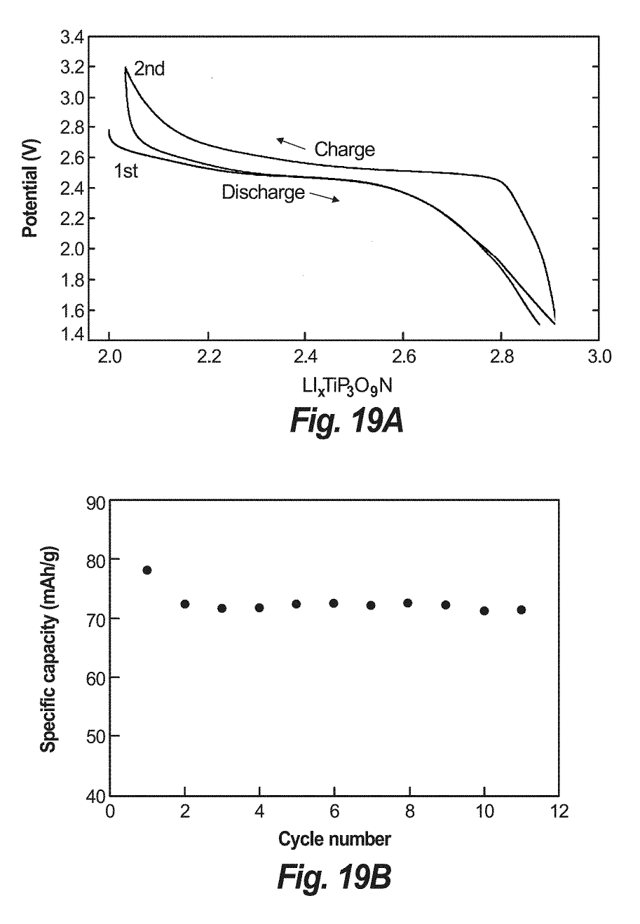

This example illustrates a production of a battery with Li₂₊ₓTiP₃O₉N as a cathode. The reaction product from Example 30 was mixed with carbon black and PVDF (polyvinylidene fluoride) in a 6:3:1 weight ratio. A minimal amount of NMP (N-Methyl-2-Pyrrolidone) was added to the mixture as the solvent to form a slurry. The slurry was then painted on an aluminum (Al) foil, with a thickness of about 5 μm, and the whole foil was dried in a vacuum drying oven at about 80° C. for about 10 hours. After that, the dried foil was cut into several round electrodes with the area of about 0.806 cm²/each. The cycling performance was evaluated inside of 2032-type coin cells, using lithium metal as the anode and commercial Samsung electrolyte (1M LiPF₆ in ethylene carbonate/dimethyl carbonate solution) as the electrolyte. The cycling was carried out between 1.5 V and 3.2 V at room temperature at a C/10 rate, corresponding to 0.015 mA/cm². FIG. 19A shows the first and second voltage charge-discharge profiles of Li₂₊ₓTiP₃O₉N cycled against Li⁺/Li between 1.5 V and 3.2 V at C/15. During lithium insertion/extraction, a solid solution type reaction has been found with the active redox potential centered at about 2.5 V. The cycling performance of Li₂₊ₓTiP₃O₉N shown in FIG. 19B confirms that lithium ions can be reversibly inserted/extracted within the structure of this nitridophosphate.

### Example 33

This example illustrates the synthesis of Li₂Mg₂P₃O₉N. Na₂Mg₂P₃O₉N of Example 25 and LiBr were mixed in a molar ratio of 1:10. The mixture was heated up to about 320° C. for about 20 hours in a tube furnace under a flow of N₂ gas. The product was washed with methanol and then mixed with another batch of fresh LiBr in the same molar ratio as before. This process was repeated 4 times. The final product was identified by X-ray diffraction to contain a cubic phase with lattice parameter about 9.12 Å. This phase was identified to be Li₂Mg₂P₃O₉N.

### Example 34

This example illustrates the synthesis of LiₓFe₂P₃O₉N. Na₂Fe₂P₃O₉N of Example 13 and LiBr were mixed in a molar ratio of 1:10. The mixture was heated up to about 300° C. for about 20 hours in a tube furnace under a flow of N₂ gas. The product was washed with methanol and then mixed with another batch of fresh LiBr in the same molar ratio as before. This process was repeated 3 times. The final product was identified by X-ray diffraction to contain a cubic phase with lattice parameter about 9.10 Å. This phase was identified to be LiₓFe₂P₃O₉N.

### Example 35

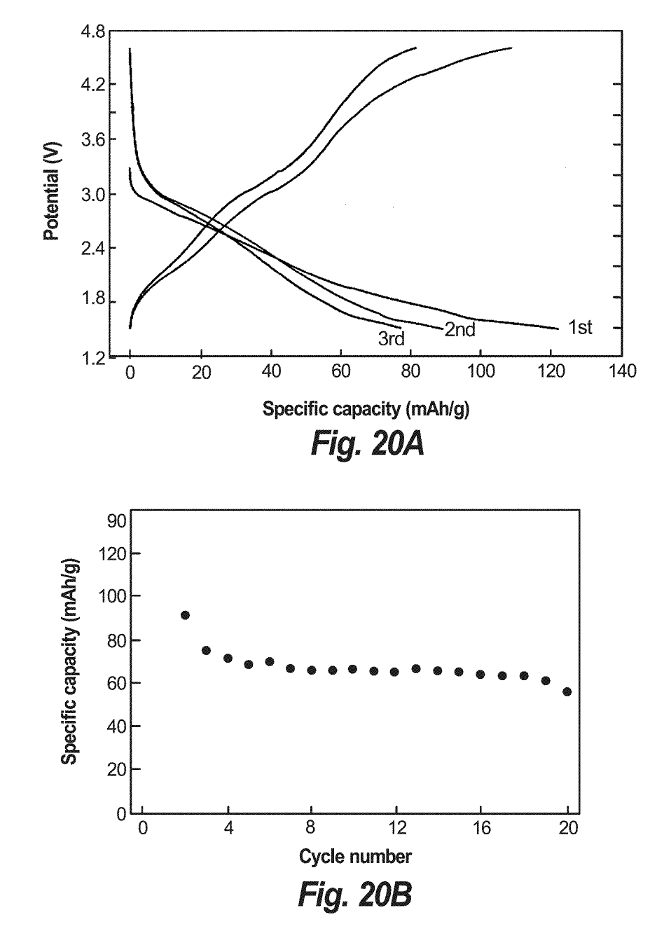

This example illustrates a production of a battery with LiₓFe₂P₃O₉N as a cathode. The reaction product from Example 34 was mixed with carbon black and PVDF (polyvinylidene fluoride) in a 6:3:1 weight ratio. A minimal amount of NMP (N-Methyl-2-Pyrrolidone) was added to the mixture as the solvent to form a thick slurry. The slurry was then painted on an aluminum (Al) foil, with a thickness of about 5 μm, and the whole foil was dried in a vacuum oven at about 80° C. for about 6 h. After that, the dried foil was cut into several round electrodes with the area of about 0.806 cm²/each. The cycling performance was evaluated inside of 2032-type coin cells, using lithium metal as the anode and commercial Samsung electrolyte (1M LiPF₆ in ethylene carbonate/dimethyl carbonate solution) as the electrolyte. The cycling was carried out between 2.0 V and 4.2 V (versus Li⁺/Li) at room temperature at a C/20 rate, corresponding to 0.012 mA/cm² (see FIG. 20A). An initial discharge capacity of 130 mAh/g was achieved with electrochemical active potential centered at about 2.2 V. However, serious capacity fading was observed after the first cycle as illustrated in FIG. 20B. After 10 cycles, the capacity stabilized at about half of the theoretical capacity (theoretical capacity is ˜135 mAh/g). A large voltage hysteresis between charge and discharge profile was also observed. The active potential during charge process was found to be centered at about 3.5V.

All publications and patents mentioned in the above specification are incorporated by reference in their entireties in this disclosure. Various modifications and variations of the described nanomaterials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching of this disclosure and no more than routine experimentation, many equivalents to the specific embodiments of the disclosed invention described. Such equivalents are intended to be encompassed by the following claims.

1. A solid electrolyte comprising a cubic ionic conductor compound having a framework of formula (1) with a general chemical formula (2)
[MT₃X₁₀]ⁿ⁻ (1)
AₓMT₃X₁₀ (2)
where M is a cation in octahedral coordination, T is a cation in tetrahedral coordination, X is an anion, n is a net charge of the framework between 0 and 16, A is a variable number of additional non-framework chemical species that can fit into an open space within the framework with a net charge of +n, and x is less than 10, wherein a T₃X₁₀ trimer of TX₄ tetrahedra share one common Xanion, organized around an octahedral MX₆ site such that each MX₆ octahedron is connected to three different T₃X₁₀ trimers by two bridging X anions connected to two different TX₄ tetrahedra within the trimer, and wherein the solid state electrolyte can accept excess mobile ions.

2. The solid electrolyte of claim 1, wherein the T₃X₁₀ trimer of formula (1) is P₃O₉N forming a nitridophosphate compound having a general formula (3)
AₓM(PO₃)₃N (3)
where x≦3, and A is an ionic or neutral species and the combination of A and M species produce a +6 charge that results in a net charge neutrality.

3. The solid electrolyte of claim 2, wherein A and M are ions or neutral species with closed shell configurations and no unpaired electrons.

4. The solid electrolyte of claim 2, wherein A and M are selected from a combination of one or more monopositive cations among H, Li, Na, K, Cu, Ag, H₃O or NH₄, and a combination of one or more fully oxidized cations selected from among Sc, Ti, Zr, Hf, V, Nb, Ta, Cr, Mo, W, Mg, Zn, Ca, Sr, Al, Ga, or In.

5. The solid electrolyte of claim 2, wherein the nitridophosphate compound has a specific formula of Na₃Al(PO₃)₃N, Na₃Ga(PO₃)₃N, Na₃In(PO₃)₃N, Na₂Ti(PO₃)₃N, Na₁V(PO₃)₃N, K₃A1(PO₃)₃N, K₃Ga(PO₃)₃N, K₃In(PO₃)₃N, K₂Ti(PO₃)₃N, or K₁V(PO₃)₃N.

6. The solid electrolyte of claim 2, wherein the solid state electrolyte forms a membrane or a layer.

7. An electrochemical cell comprising:
a cathode,
an anode, and
an electrolyte solution,
wherein the electrolyte solution comprises an electrode of claim 1.
